(19) United States
(12) Patent Application Publication
(10) Pub. No.: US 2019/0089515 A1
(43) Pub. Date: Mar. 21, 2019

(54) ELECTRONIC APPARATUS AND WIRELESS COMMUNICATION METHOD

(71) Applicant: KABUSHIKI KAISHA TOSHIBA, Tokyo (JP)

(72) Inventors: Narendar MADHAVAN, Tokyo (JP); Toshihisa NABETANI, Kawasaki (JP); Tsuguhide AOKI, Kawasaki (JP)

(73) Assignee: KABUSHIKI KAISHA TOSHIBA, Tokyo (JP)

(21) Appl. No.: 15/911,434

(22) Filed: Mar. 5, 2018

(30) Foreign Application Priority Data
Sep. 19, 2017 (JP) 2017-179544

(51) Int. Cl. H04L 5/00; H04W 52/24

(52) U.S. Cl. CPC H04L 5/0073; H04W 74/004; H04W 52/243

(57) ABSTRACT

According to one embodiment, an electronic apparatus includes a receiver configured to receive a first frame in a first frequency band within a first period from a first apparatus; and a transmitter configured to transmit a second frame in the first frequency band within the first period to a second apparatus. A transmission power of the second frame depends on both a reception quality required by the second apparatus to receive the second frame and an amount of interference from the first apparatus to the second apparatus.

### CROSS REFERENCE TO RELATED APPLICATIONS

This application is based upon and claims the benefit of priority from the prior Japanese Patent Application No. 2017-179544, filed on Sep. 19, 2017, the entire contents of which are incorporated herein by reference.

### FIELD

Embodiments described herein relate to an electronic apparatus and a wireless communication method.

### BACKGROUND

For the next-generation standard of IEEE 802.11ax, a technique of full duplex communication through which a single terminal simultaneously performs transmission and reception in the same frequency band is discussed as a technique of improving system throughput in an environment where many terminals reside.

One of the problems caused in realization of full duplex communication is a problem of inter-node interference. The inter-node interference is an interference applied to a terminal that performs downlink reception by a transmission signal from a terminal that performs uplink transmission. For example, a case is discussed where a certain terminal uplink-transmits a signal to an access point, and this access point simultaneously downlink-transmits a signal to another terminal at the same frequency band. When the signal uplink-transmitted by the certain terminal to the access point reaches the other terminal, this signal applies an interference (inter-node interference) to the signal downlink-received by the other terminal from the access point. This interference serves as a factor to cause a possibility of preventing the other terminal from correctly receiving the downlink signal. As described above, the inter-node interference is a cause of reducing the system throughput in realization of full duplex communication.

### BRIEF DESCRIPTION OF THE DRAWINGS

FIG. 1 is a diagram showing a wireless communication system according to a first embodiment;

FIG. 2 is a diagram showing the inter-node interference of full duplex communication;

FIG. 3 is a diagram illustrating the inter-node interference of full duplex communication;

FIG. 4 is a diagram showing a schematic configuration example of a physical packet;

FIGS. 5A and 5B are diagrams showing basic format examples of MAC frames;

FIG. 6 is a functional block diagram of the wireless communication device at an access point according to the first embodiment;

FIG. 7 is a functional block diagram of the wireless communication device at a terminal according to the first embodiment;

FIG. 8 is a diagram showing an example of a frame sequence according to the first embodiment;

FIG. 9 is a diagram showing a format example of an FD-RTS frame;

FIG. 10 is a diagram showing a format example of an FD-CTS frame;

FIG. 11 is a flowchart of an operation at the access point according to this embodiment;

FIG. 12 is a diagram showing an example of a frame sequence according to a second embodiment;

FIG. 13 is a diagram showing a format example of an FD trigger frame;

FIG. 14 is a diagram showing an example of a frame sequence according to a third embodiment;

FIG. 15 is a diagram showing an example of full duplex communication according to a fourth embodiment;

FIG. 16 is a diagram showing another example of full duplex communication according to the fourth embodiment;

FIG. 17 is a functional block diagram of the access point or the terminal;

FIG. 18 is a diagram showing an example of an overall configuration of the terminal or the access point;

FIG. 19 is a diagram showing a hardware configuration example of a wireless communication device mounted on the access point or the terminal;

FIG. 20 is a functional block diagram of the terminal or the access point;

FIGS. 21A and 21B are perspective views of the terminal according to an embodiment of the present invention;

FIG. 22 is a diagram showing a memory card according to an embodiment of the present invention; and

FIG. 23 is a diagram showing an example of frame exchange in a contention duration.

### DETAILED DESCRIPTION

According to one embodiment, an electronic apparatus includes a receiver configured to receive a first frame in a first frequency band within a first period from a first apparatus; and a transmitter configured to transmit a second frame in the first frequency band within the first period to a second apparatus. A transmission power of the second frame depends on both a reception quality required by the second apparatus to receive the second frame and an amount of interference from the first apparatus to the second apparatus.

IEEE Std 802.11™-2012 and IEEE Std 802.11ac™-2013, which are known as the specifications of wireless LAN standards, are incorporated by reference in this specification.

Hereinafter, referring to the drawings, embodiments of the present invention will be described.

### First Embodiment

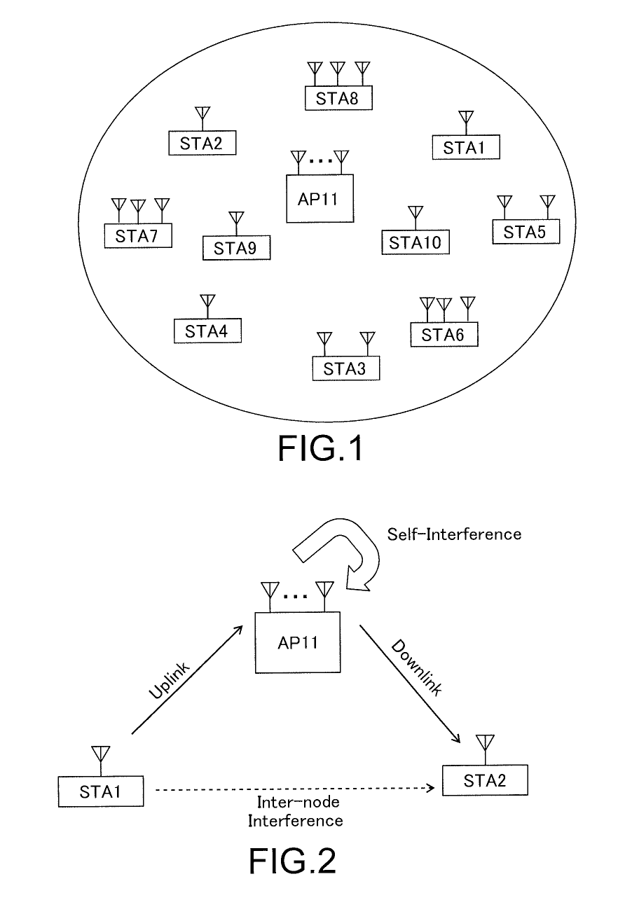

FIG. 1 shows a wireless communication system according to this embodiment. The wireless communication system is a wireless LAN (Local Area Network) that includes access point (AP) 11 serving as a base station, and multiple wireless terminals (hereinafter referred to as terminals or stations) 1, 2, 3, 4, 5, 6, 7, 8, 9 and 10. In the wireless LAN, communication based on CSMA/CA (Carrier Sense Multiple Access/Collision Avoidance) is performed.

AP 11 has the function of the terminal. Accordingly, AP 11 can be regarded as a mode of the terminal, but is different from terminals 1 to 10 in that AP 11 has a relay function and the like. AP 11 and terminals 1 to 10 communicate according to IEEE 802.11 standard. Alternatively, a configuration of communication according to another communication scheme may be adopted. For the sake of simplicity, FIG. 1 shows only 10 terminals other than AP. Alternatively, a larger or smaller number of terminals may reside. In the following description, the terminal may indicate AP except for cases where the terminal cannot be regarded as AP.

AP 11 includes one or more antennas. The antenna may be a directional variable antenna. AP 11 is mounted with a wireless communication device that transmits and receives a MAC frame via an antenna. The wireless communication device is an electronic apparatus. In the following description, the MAC frame is simply described as a frame in some cases. The wireless communication device mounted on AP 11 includes: a wireless communicator that wirelessly transmits and receives a signal; and a controller or a communication control device that controls communication by transmitting and receiving a frame via the wireless communicator. AP 11 forms a wireless communication group that is a Basic Service Set (BSS) in IEEE 802.11 standard, for example. AP 11 establishes wireless links to terminals 1 to 10 by preliminarily performing an association process. A state where the wireless link is established is represented as connection to AP 11. AP 11 communicates with terminals 1 to 10 respectively via the established wireless links. AP 11 does not necessarily have the function of AP defined in IEEE 802.11 standard, as long as the communication between terminals can be relayed. In this case, AP 11 operates as a relay station that relays communication between terminals. The wireless communicator included in AP 11 is made up of an RF (Radio Frequency) integrated circuit, for example. The controller or the communication control device included in AP 11 is made up of controlling circuitry such as a baseband integrated circuit, for example.

Terminals 1 to 10 each include one or more antennas. The antenna may be a directional variable antenna. Terminals 1 to 10 are each mounted with a wireless communication device that transmits and receives a frame via the antenna. Terminals 1 to 10 corresponds to first to tenth apparatuses, for example. The wireless communication device mounted on each of terminals 1 to 10 includes: a wireless communicator that wirelessly transmits and receives a signal; and a controller or a communication control device that controls communication by transmitting and receiving a frame via the wireless communicator. The wireless communicator included in each terminal is made up of an RF (Radio Frequency) integrated circuit, for example. The controller or the communication control device included in each terminal is made up of a baseband integrated circuit, for example.

AP 11 may be connected further to a network other than the wireless network to which terminals 1 to 10 belong. The other network may be a wired network, a wireless network, or a hybrid network thereof. AP 11 may relay communication between the network to which terminals 1 to 10 belong and another network.

AP 11 has the function of full duplex communication according to this embodiment. AP 11 can simultaneously transmit a frame and receive a frame to and from multiple terminals among terminals 1 to 10 in the same frequency band (same channel). It is assumed that terminals 1 to 10 have the function of half duplex communication. Alternatively, terminals 1 to 10 may have the function of full duplex communication. In this case, AP 11 can simultaneously receive a frame and transmit a frame from and to one terminal in the same frequency band.

FIG. 2 is a diagram showing an example of full duplex communication according to this embodiment. AP 11 downlink-transmits a frame to terminal 2, and simultaneously uplink-receives a frame from terminal 1. That is, terminal 1 is a transmission source device (uplink transmission terminal) that uplink-transmits a frame, and terminal 2 is a transmission destination device (which is below called downlink transmission destination terminal or downlink reception terminal) serving as a destination of a downlink-transmitted frame.

In a case where a signal uplink-transmitted to AP 11 also reaches terminal 2 to which AP 11 performs downlink transmission, this signal serves as an interference signal to a signal that is to be downlink-received by terminal 2. Such interference is referred to as inter-node interference. There is a possibility that the inter-node interference prevents the other terminal from correctly receiving the downlink signal. The correct reception of the signal means reception of the frame with a reception quality (e.g., SINR (Signal-to-Interference-plus-Noise Ratio) etc.) equal to or less than a certain frame error rate, for example. In order to allow terminal 2 to receive a downlink signal correctly, the reception quality at terminal 2 is required to be secured. The reception quality required for terminal 2 is represented using the required SINR, for example. Consequently, the required SINR for terminal 2 is needed to be satisfied. The required SINR for terminal 2 is predefined. The required SINR may be determined on the basis of at least one item among items, such as the QoS, data type, and MCS (Modulation and Coding Scheme), as an example. The required SINR may be determined using any related technique. In this embodiment, further detailed description of the method of determining the required SINR is omitted.

It is assumed that the required SINR for terminal 2 is “α_{Required}”, the reception power of the signal downlink-received by terminal 2 from AP 11 is “β_{RX}”, and the reception power (amount of interference) of the interference signal received by terminal 2 from terminal 1 is “γ_{RX}”. The interference signal is a signal uplink-transmitted by terminal 1 to AP 11 and received by terminal 2. RSSI (Received Signal Strength Indicator) is assumed as an example of the reception power in this embodiment. However, the example is not limited thereto. In order to satisfy the required SINR for terminal 2, the following Expression (1) is required to be satisfied. That is, the value obtained by dividing “β_{RX}” by “γ_{RX}” is required to be “α_{Required}” or more.

$${α}_{Required} \leq \frac{{β}_{RX}}{{γ}_{RX}} \qquad Expression ( 1 )$$

“β_{RX}” and “γ_{RX}” are defined as follows. “−” is a symbol that represents subtraction.

β_{RX}=P_{DL@AP}−P_{Loss(AP→STA2)} Expression (2)

γ_{RX}=P_{UL@STA1}−P_{Loss(AP→STA2)} Expression (3)

“P_{DL@AP}” is the transmission power for downlink transmission by AP 11 to terminal 2.

“P_{Loss(AP→STA2)}” is the path loss (amount of destination attenuation) of the signal downlink-transmitted by AP 11 to terminal 2.

“P_{UL@STA1}” is the transmission power for uplink transmission by terminal 1 to AP 11.

“P_{Loss(STA1→STA2)}” is the path loss of the signal uplink-transmitted by terminal 1 to AP 11 against terminal 2.

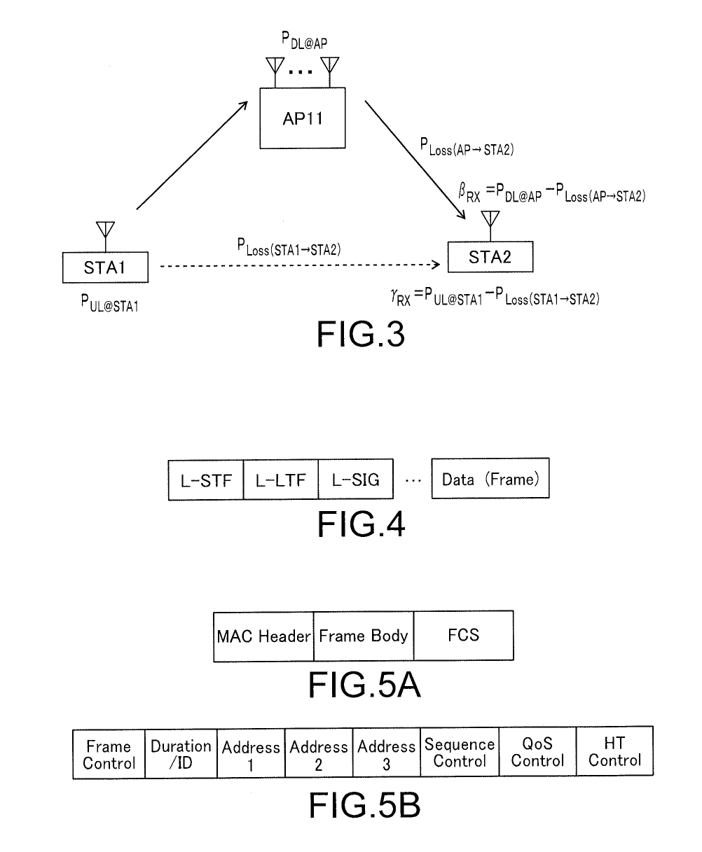

FIG. 3 shows these symbols assigned to corresponding positions in FIG. 2.

Instead of Expression (1), following Expression (4) may be used.

α_{Required}≤β_{RX}−γ_{RX} Expression (4)

In the following description, Expression (1) is assumed.

Expression (1) is rewritten using Expressions (2) and (3), thereby achieving the following Expression (5).

$${α}_{Required} \leq \frac{{P}_{DL @ AP} - {P}_{Loss ( AP -> STA 2 )}}{{P}_{UL @ STA 1} - {P}_{Loss ( STA 1 -> STA 2 )}} \qquad Expression ( 5 )$$

Before start of full duplex communication, AP 11 transmits a frame to terminal 2, and causes terminal 2 to measure “P_{Loss(AP→STA2)}”, and obtains a measurement result. AP 11 causes terminal 2 to receive a frame from terminal 1 and to measure the power of the received frame. AP 11 obtains information on “P_{Loss(STA1→STA2)}” from terminal 2. AP 11 determines one of “P_{DL@AP}” and “P_{UL@STA1}” according to any method, and determines the other according to the relationship of Expression (5). Full duplex communication is performed with the determined “P_{DL@AP}” and “P_{UL@STA1}”. That is, terminal 1 uplink-transmits a frame to AP 11 with P_{UL@STA1}, and AP 11 downlink-transmits the frame to terminal 2 with “P_{DL@AP}”. Accordingly, terminal 2 can correctly (satisfying the required SINR) receive the frame downlink-transmitted from AP 11, irrespective of the inter-node interference.

In full duplex communication, AP 11 causes self-Interference (see FIG. 2). More specifically, the signal downlink-transmitted to terminal 2 is leaked toward a receiver on a predetermined path in the own terminal, and the transmission signal is reflected. Such leakage and reflection cause self-interference against the signal to be uplink-received. The self-interference degrades the reception quality of an uplink-received signal. However, in this embodiment, AP 11 includes a scheme of canceling the self-interference signal.

The overview of this embodiment has thus been described above. This embodiment is hereinafter described further in detail.

In this embodiment, the frame is transmitted and received as communication. More specifically, a physical packet that includes a frame, and a physical header added to the frame is transmitted and received. In the following description, in a case where a representation that a frame is transmitted or received is used, a physical packet including the frame is transmitted or received in actuality. The physical packet (sometimes simply referred to as the packet) corresponds to PPDU (Physical Layer Protocol Data Unit) in IEEE 802.11 standard.

FIG. 4 illustrates a schematic configuration example of a physical packet. The physical packet includes a physical header and a frame added to the end of the physical header. As an example, the physical header includes L-STF (Legacy-Short Training Field), L-LTF (Legacy-Long Training Field) and L-SIG (Legacy Signal Field) defined in accordance with the IEEE 802.11 standard. L-STF, L-LTF, and L-SIG are fields that can be recognized by terminals of legacy standards such as IEEE 802.11 b/a/n/ac and the like, and pieces of information such as information for signal detection, information for frequency correction (or reception power measurement or propagation path estimation), transmission rate (MCS (Modulation and Coding Scheme)), and the like are stored therein. L-STF and L-LTF constitute a legacy preamble part. Fields other than those mentioned herein may be included.

FIG. 5A illustrates an example of a basic format of a MAC frame. This frame format includes fields of MAC header, frame body, and FCS. As illustrated in FIG. 5B, the MAC header includes fields of Frame Control, Duration/ID, Address 1, Address 2, Address 3, Sequence Control, QoS Control, and HT (High Throughput) control.

All of these fields need not necessarily be provided and some of these fields may not be provided. For example, the Address 3 field may not be provided. In addition, there may be cases in which either or both of QoS Control and HT Control fields do not exist. There may be cases where the frame body field does not exist. On the other hand, other fields not illustrated in FIG. 3B may also be provided. For example, an Address 4 field may be additionally provided. The HT Control field may be expanded to other fields depending on the standard in use, for example, VHT (Very High Throughput) or HE (High Efficiency) Control field.

A receiver address (RA) is entered in the field of Address 1, a transmitter address (TA) is entered in the field of Address 2, and a BSSID (Basic Service Set IDentifier) which is an identifier of a basic service set (BSS) (which may be a wildcard BSSID covering all BSSIDs with all the bits set to 1) or a TA is entered in the field of Address 3 depending upon the purpose of the frame.

The Frame Control field includes two fields of Type and Subtype. Rough discrimination of the frame type of whether it is a data frame, a management frame, or a control frame is performed based on the Type field, and more specific discrimination of the roughly discriminated frames is performed based on the Subtype field.

The Duration/ID field describes a medium reservation time, and it is determined that the medium is virtually busy from the end of the physical packet including the MAC frame to the medium reservation time when a MAC frame addressed to another terminal has been received. The Sequence Control field stores the sequence number of the frame and the like. The QoS field is used to perform QoS control such that transmission is performed taking into consideration the priority of the frames. The HT Control field is a field introduced by IEEE 802.11n.

FCS (Frame Check Sequence) information is set in the FCS field as a checksum code used in frame error detection at the receiving side. As an example of the FCS information, CRC (Cyclic Redundancy Check or Cyclic Redundancy Code) may be mentioned.

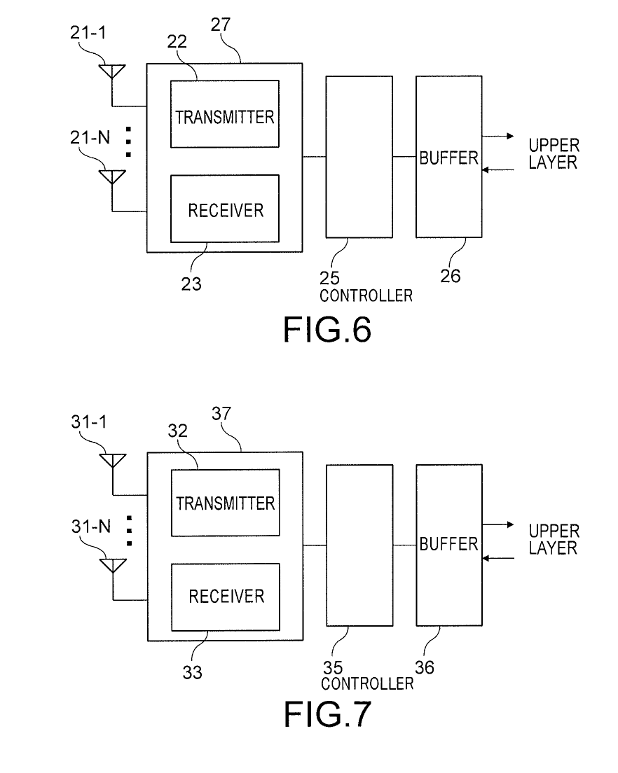

FIG. 6 shows a functional block diagram of a wireless communication device at AP 11 according to this embodiment. The wireless communication device according to this embodiment can execute full duplex communication that transmits and receives frames simultaneously (i.e., in parallel) in the same frequency band.

The wireless communication device shown in FIG. 6 includes at least one antenna 21-1 to 21-N (N is an integer of one or more), wireless communicator 27, controller 25, and buffer 26. Wireless communicator 27 includes transmitter 22, and receiver 23. Wireless communicator 27 has a self-interference cancellation function. In the case of multiple antennas, different antennas may be used for transmission and reception, or an antenna may be shared for transmission and reception. In the case where the antenna is shared for transmission and reception, the connection destination of the antenna may be switched between transmitter 22 and receiver 23 with a switch.

The process in each block in FIG. 6 may be performed by software (program) operating in a processor, such as CPU, hardware, such as a circuit, or performed by both of software and hardware. The process in each block may be performed by an analog process, a digital process, or both the analog process and the digital processes.

Controller 25 mainly performs the process on the MAC layer and a part of the process on the physical layer. Controller 25 manages the MAC layer and the physical layer, and stores information required for management in a buffer in controller 25 or outside thereof. Information pertaining to the terminal connected to AP 11, and also information pertaining to this AP itself may be managed through the buffer. The buffer may be a device, such as a memory, an SSD, or a hard disk. In the case of the memory, this memory may be a volatile memory, such as DRAM, or a nonvolatile memory, such as NAND or MRAM. This buffer may be the same storage medium as buffer 26, or another storage medium.

In a case where data or information to be transmitted is stored in buffer 26, controller 25 generates a frame that contains the data or information, obtains a transmission right according to a communication scheme to be used, and transmits the frame through transmitter 22. The transmission right corresponds to an access right to the wireless medium. For example, a carrier sensing is performed on the basis of CSMA/CA (Carrier Sense Multiple Access with Collision Avoidance). If the transmission right is obtained with the wireless medium being idle, a frame (more specifically, a physical packet that includes the frame and a physical header added to this frame) is transmitted to transmitter 22 in TXOP (Transmission Opportunity) based on the transmission right. TXOP corresponds to a time period during which the wireless medium can be occupied. A part of or the entire physical header may be added by transmitter 22. Controller 25 may output, to transmitter 22, a signal that indicates at least one of the transmission rate (MCS) applied to the frame or packet, and the transmission power.

Transmitter 22 encodes and modulates the packet passed from controller 25, and applies DA (Digital to Analog) conversion thereto to generate an analog signal. Transmitter 22 extracts a signal component in a desired band from the analog signal, and causes an amplifier to amplify the extracted signal. Transmitter 22 then transmits the amplified signal via antennas 21-1 to 21-N. When MCS is designated by controller 25, transmitter 22 encodes and modulates the frame or packet on the basis of MCS. When the transmission power is designated by controller 25, transmitter 22 adjusts the operation of the amplifier so as to achieve transmission with this transmission power. When the MCS to be applied to the frame is set in the physical header of the packet passed from controller 25, transmitter 22 may encode and modulate the frame on the basis of the MCS set in the physical header.

Receiver 23 causes a Low Noise Amplifier (LNA) to amplify the signals received via antennas 21-1 to 21-N, frequency-converts (down-converts) the signals, and applies a filtering process thereto to extract a desired band component. Receiver 23 AD-converts the extracted signal into a digital signal, demodulates, error-correction-decodes, and applies a physical header process to the digital signal, and obtains the frame. Receiver 23 inputs the frame into controller 25. A part of or the entire physical header process may be performed by controller 25.

Upon receipt of the frame that requires an acknowledgement response, controller 25 generates an acknowledgement response frame (an ACK frame, a BA (Block Ack) frame, etc.) in response to an inspection result of the received frame, and transmits the generated acknowledgement response frame via transmitter 22.

Buffer 26 is used as a storage area for exchanging data between an upper layer and controller 25. Buffer 26 may temporarily store data contained in the frame received from the terminal in order to relay the data to another terminal. Upon receipt of the frame destined for this station, the data may be temporarily stored in buffer 26 in order to pass the data in the frame to the upper layer. The upper layer performs a process pertaining to a communication protocol, such as TCP/IP or UDP/IP, which is upper than the MAC layer. The upper layer may perform a process for the application layer besides the process for TCP/IP or UDP/IP. The operation of the upper layer may be performed through software (program) operating in a processor, such as CPU, through hardware, or through both software and hardware.

Controller 25 performs full duplex communication and accompanying various processes. For example, controller 25 performs full-duplex transmission power control, scheduling of full duplex communication, and switching control between full duplex and half duplex communications. Furthermore, controller 25 may perform transmission power control and transmission rate control for another terminal.

Wireless communicator 27 has a function (self-interference cancellation function) of performing a process of canceling the self-interference signal that occurs in this device during full duplex communication. During full duplex communication, the signal is leaked from transmitter 22 to receiver 23, and this signal serves as a self-interference signal to degrade the characteristics of the reception signal. That is, a part of the transmission signal (self-interference signal) is mixed in the signals received via antennas 21-1 to 21-N. The amplitude of the part of the transmission signal is added as the amount of interference to the reception signal, and the signal containing the added amount is input into receiver 23. The self-interference cancellation function of wireless communicator 27 removes the self-interference signal having been leaked from transmitter 22 to receiver 23 and received.

The method of removing the self-interference signal may be any method. For example, the method may be a method of providing a circuit for securing isolation between transmitter 22 and receiver 23 so as not to leak the transmission signal to receiver 23. In this case, the self-interference cancellation function is arranged as a circuit for isolation. There is another method of providing a path through which the transmission signal output from transmitter 22 is wirelessly or wiredly input into receiver 23 or an upstream circuit, and of subtracting the amplitude (amount of interference) of the transmission signal input through the path, from the mixed signal of the reception signal and the self-interference signal. In this case, the circuit that executes the self-interference cancellation function includes a circuit that includes this path, and subtracts the transmission signal from the mixed signal.

Upon receipt of a frame (FD-RTS frame described later) for request for full-duplex uplink transmission to be made from the terminal, controller 25 determines full-duplex parameter information, such as the start timing of full duplex communication (start time point etc.), the packet length (the length of full duplex duration) in full duplex communication, the terminal that serves as the full-duplex downlink transmission destination, and the frequency band (channel) used in full duplex communication. Controller 25 generates a frame (FD-CTS frame described later) in which the determined parameter information is set, and broadcasts or multicast-transmits the frame through transmitter 22 a certain time period (e.g., SIFS) after completion of receiving FD-RTS frame.

Controller 25 of AP 11 receives a response frame (FD-CTS frame described later) from the terminal determined as the downlink transmission destination, a certain time period (e.g., SIFS) after completion of transmitting the FD-CTS frame. The response frame contains information that represents the path loss from AP 11 to the downlink transmission destination terminal, and the path loss from the terminal having received the FD-RTS frame to the downlink transmission destination terminal. Controller 25 determines the downlink transmission power on the basis of these path losses, the transmission power for uplink transmission by terminal 1, and the reception quality (e.g., SINR) required for downlink reception by the downlink transmission destination terminal. The details are described later.

When the start time point of the full duplex duration notified by FD-CTS frame 52 is reached, controller 25 transmits a frame, such as a data frame, to the downlink transmission destination terminal via transmitter 22. The frequency band to be used may be preliminarily determined. In a case where the frequency band is notified in FD-CTS frame 52, the notified frequency band is used. At the same time, receiver 23 receives the frame, such as data frame, uplink-transmitted in the frequency band from the terminal having issued the uplink transmission request. That is, controller 25 transmits the frame to the downlink transmission destination terminal within a first period and receiver 23 receives the frame within the first period from the terminal having issued the uplink transmission request. As described above, full duplex communication is performed.

FIG. 7 shows a configuration example of a functional block diagram of the wireless communication device of the terminal according to this embodiment. Terminals 1 to 10 in FIG. 1 has the configuration in FIG. 7, for example. The wireless communication device in FIG. 7 includes at least antennas 31-1 to 31-N (N is an integer of two or more), wireless communicator 37, controller 35, and buffer 36. Wireless communicator 37 includes transmitter 32, and receiver 33.

In the case where multiple antennas 31-1 to 31-N are included, different antennas may be used for transmission and reception, or the antennas may be shared for transmission and reception. In the case where the antennas are shared for transmission and reception, the connection destinations of the antennas may be switched between transmitter 32 and receiver 33 with a switch.

The process in each block in FIG. 7 may be performed by software (program) operating in a processor, such as CPU, hardware, such as a circuit, or performed by both of software and hardware. The process in each block may be performed by an analog process, a digital process, or both the analog process and the digital processes.

Controller 35 is a controller that controls communication with AP 11, and mainly performs a part of the process on the MAC layer and the process on the physical layer. Controller 35 performs control processes, such as of transmission power control and transmission rate control, as a specific example of communication control. Controller 35 performs full duplex communication and accompanying various processes. Controller 35 manages the MAC layer and the physical layer, and stores information required for management in a buffer in controller 35 or outside thereof. Information pertaining to AP 11, and information pertaining to this terminal itself may be managed through the buffer. The buffer may be a device, such as a memory, an SSD, or a hard disk. In the case of the memory, this memory may be a volatile memory, such as DRAM, or a nonvolatile memory, such as NAND or MRAM. This buffer may be the same storage medium as buffer 36, or another storage medium.

In a case where data or information to be transmitted is stored in buffer 36, controller 35 generates a frame that contains the data or information, obtains a transmission right according to a communication scheme to be used, and transmits the frame through transmitter 32. The transmission right corresponds to an access right to the wireless medium. For example, when a carrier is sensed on the basis of CSMA/CA, and the transmission right is obtained with the wireless medium being idle, a frame (more specifically, a physical packet that contains the frame and a physical header added to this frame) is output to transmitter 32 in TXOP based on the transmission right. A part of or the entire physical header may be added by transmitter 32. Controller 35 may output, to transmitter 32, a signal that indicates at least one of the transmission rate (MCS) applied to the frame or packet, and the transmission power.

Transmitter 32 encodes and modulates the packet passed from controller 35, and applies DA (Digital to Analog) conversion thereto to generate an analog signal. Transmitter 32 extracts a signal component in a desired band from the analog signal, and causes an amplifier to amplify the extracted signal. Transmitter 32 then transmits the amplified signal via antennas 31-1 to 31-N. When the MCS is designated by controller 35, transmitter 32 encodes and modulates the frame or packet on the basis of MCS. When the transmission power is designated by controller 35, transmitter 32 adjusts the operation of the amplifier so as to achieve transmission with this transmission power. When the MCS to be applied to the frame is set in the physical header of the packet passed from controller 35, transmitter 32 may encode and modulate the frame on the basis of the MCS set in the physical header.

Receiver 33 causes a Low Noise Amplifier (LNA) to amplify the signal received via the antenna, frequency-converts (down-converts) the signal, and applies a filtering process thereto to extract a desired band component. Receiver 33 AD-converts the extracted signal into a digital signal, demodulates, error-correction-decodes, and applies a physical header process to the digital signal, and obtains the frame. Receiver 33 inputs the frame into controller 35. A part of or the entire physical header process may be performed by controller 35.

Buffer 36 is used as a storage area for exchanging data between an upper layer and controller 35. Upon receipt of the frame destined for this terminal, the data may be temporarily stored in buffer 36 in order to pass the data in the frame to the upper layer. The upper layer performs a process pertaining to a communication protocol, such as TCP/IP or UDP/IP, which is upper than the MAC layer. The upper layer may perform a process for the application layer besides the process for TCP/IP or UDP/IP. The operation of the upper layer may be performed through software (program) operating in a processor, such as CPU, through hardware, or through both software and hardware.

When an uplink transmission request occurs, controller 35 generates a frame (FD-RTS frame described later) that requests uplink transmission. In this case, the terminal serves as an initiator of full duplex communication. In the FD-RTS frame, for example, flag information that represents an uplink transmission request, and information that specifies the transmission power used in uplink transmission are set. Other information, such as the information that specifies the transmission power for the FD-RTS frame, and the length of the packet used for uplink transmission, may be additionally set. Controller 35 transmits the generated FD-RTS frame to AP 11 via transmitter 32. Controller 35 receives, via receiver 33, a frame (FD-CTS frame described later) for notifying the permission of uplink transmission, as a response to the FD-RTS frame. Controller 35 analyzes the FD-CTS frame, and detects information, such as the start time point of full duplex communication, and the length of a packet that can be uplink-transmitted. Controller 35 generates a packet that has this packet length, and uplink-transmits the generated packet through transmitter 32 at the start time point. If the other condition, such as the frequency band to be used, is designated in the FD-CTS frame, the uplink transmission is performed according to the condition.

Upon receipt of the FD-RTS frame from another terminal, controller 35 measures the reception power for the FD-RTS frame, and calculates the path loss from the other terminal to this terminal. Here, the transmission power for the FD-RTS frame may be predetermined. Alternatively, information that specifies the transmission power may be set in the FD-RTS frame. When controller 35 receives the FD-CTS frame from AP 11 in a state where no FD-RTS frame has been transmitted from this terminal, controller 35 analyzes the FD-CTS frame to thereby detect whether this terminal is designated as the terminal that serves as the full-duplex downlink transmission destination terminal. In a case where this terminal is designated, the path loss from AP 11 to this terminal is calculated from the reception power for the FD-CTS frame. Here, the transmission power for the FD-CTS frame may be predetermined. Alternatively, information that specifies the transmission power may be set in the FD-CTS frame. Controller 35 transmits, to AP 11, a response frame (e.g., FD-CTS frame) containing information that represents the path losses from AP 11 to this terminal and from another terminal to this terminal. Controller 35 receives a frame downlink-transmitted from AP 11, a certain time period after completion of transmitting the response frame. Controller 35 may preliminarily calculate the path loss from another terminal to the own terminal, and the path loss from AP 11 to the own terminal, and store the value of at least one concerned in the internal buffer. In this case, the value of at least one concerned having been preliminarily calculated may be read from the buffer, and set in the response frame (e.g., FD-CTS frame).

Terminals 1 to 10 may be so-called legacy terminals (more specifically, e.g., terminals that conform to any of IEEE 802.11b/a/n/ac), or terminals that conform to IEEE 802.11ax or the next generation standard. Note that terminals 1 to 10 are required to analyze the FD-CTS frames transmitted from AP 11 and to execute the operation in this embodiment according to the result of the analysis.

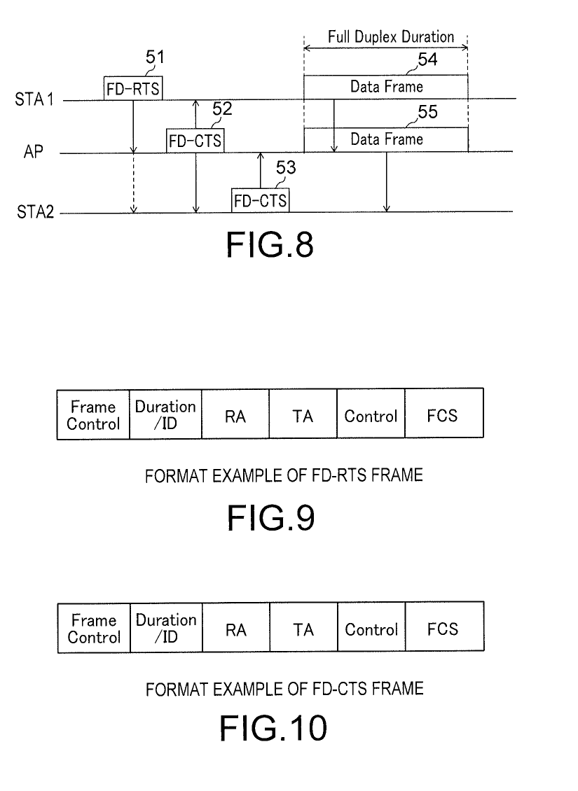

FIG. 8 shows an example of a sequence for performing full duplex communication according to this embodiment.

Terminal 1 determines to perform full-duplex uplink transmission at any timing. That is, terminal 1 serves as an initiator of full duplex communication. Terminal 1 obtains the transmission right through random backoff and transmits FD-RTS frame 51 destined for AP 11, according to CSMA/CA.

FIG. 9 shows a format example of the FD-RTS frame. This format is obtained by adding “Control” field to a conventional RTS frame. The name of “Control” field is an example. Alternatively, another name, such as “Information” field, may be adopted. The FD-RTS frame has a role as a trigger for starting full duplex communication.

In “Control” field, for example, parameter information is set. The parameter information includes, for example, flag information on the presence of a full-duplex uplink transmission request, and information that specifies the transmission power for FD-RTS frame 51 and the frame for full-duplex uplink transmission. It is herein assumed that FD-RTS frame 51, and the frame for full-duplex uplink transmission have the same transmission power. If the powers are different, different values may be set. In a case where the value of the transmission power for FD-RTS frame 51 or the value of the uplink transmission power is predefined in the standard, setting of the information that specifies the transmission power can be omitted. Other examples of the parameter information include the length of the packet intended to be full-double duplex uplink transmitted, the data frame to be full-duplex uplink transmitted, and MCS applied to the packet. Terminal 1 transmits FD-RTS frame 51 to AP 11.

In “RA” field, the MAC address of AP 11 (BSSID) is set. In “TA” field, the MAC address of this terminal itself is set. A value for specifying the FD-RTS frame is set in “Type” and “Subtype” in “Frame Control” field. For example, a value that specifies the duration to the end of FD-RTS frame 51 is set in “Duration/ID” field. In a case where the full duplex duration is preliminarily grasped or determined, a value that specifies the duration to the end of the full duplex duration may be set.

FD-RTS frame 51 transmitted by terminal 1 is received by AP 11, other terminal 2 and the like. AP 11 determines that the RD-RTS frame is destined for this station, on the basis of “RA” of FD-RTS frame 51. AP 11 detects the uplink transmission request issued by terminal 1, on the basis of the information set in “Control” field in FD-RTS frame 51. AP 11 determines the terminal to which this station performs full-duplex downlink transmission. For example, AP 11 determines the downlink transmission destination terminal according to the downlink transmission scheduling, on the basis of information that relates to the type and amount of data destined for multiple terminals and is stored in the buffer of this station. Here, it is assumed that terminal 2 is determined.

AP 11 determines the packet length that serves as the full duplex duration length, and the start time point of full duplex communication. The packet length may be the packet length desired by terminal 1, the length of the packet intended to be downlink-transmitted, or the longer one or shorter one between both the packet lengths. AP 11 may grasp the state of the buffer that stores each terminal's data for uplink transmission, by receiving buffer state notification from each terminal. In this case, the packet length may be determined using the state of the buffer. Alternatively, the packet length may be a fixed length. The start time point of full duplex communication is a time point SIFS-after completion of receiving the response frame (FD-CTS frame 53) from terminal 2 described later, or a time point thereafter. As to the specific determination method, the time point may be a certain time period after a predetermined reference time point, or may be determined by any different method. The predetermined reference time point may be the time point of start or completion of receiving RD-RTS frame 51, or another time point. Alternatively, the start time point may be determined by terminal 1 and notified in FD-RTS frame 51, and the notified start time point may be adopted.

AP 11 may measure the reception power of FD-RTS frame 51, and calculate path loss “P_{Loss(STA1→AP)}” from terminal 1 to AP 11. The reception power can be measured using a known signal in the physical header, for example. Path loss “P_{Loss (STA1→AP)}” is calculated from the difference between the measured reception power and the transmission power for FD-RTS frame 51.

AP 11 generates FD-CTS frame 52 as a response frame to FD-RTS frame 51, and transmits FD-CTS frame 52 a predetermined time period (e.g., SIFS etc.) after receipt of the RD-RTS frame.

FIG. 10 shows a format example of the FD-CTS frame. The FD-CTS frame has a format analogous to that of the RTS frame. A configuration where “TA” field is omitted can be adopted.

Identification information (here, the identification information on terminal 2) on the downlink transmission destination terminal is set in “Control” field. The identification information may be any piece of information, such as an AID (Association ID) or an MAC address, as long as the terminal can be identified by the information. Here, a case where the AID of terminal 2 is set is assumed. Information that specifies the packet length serving as the full duplex duration length, and the start time point of full duplex communication is set in “Control” field.

The MAC address of the terminal (here, terminal 1) serving as the transmission destination of FD-RTS frame 51 is set in “RA” field. In “TA” field, the MAC address of AP 11 itself is set. A value for specifying FD-CTS frame 52 is set in “Type” and “Subtype” in “Frame Control” field. For example, a value that specifies the end of the full duplex duration in “Duration/ID” field. Accordingly, NAV during full duplex communication can be set for other terminals receiving FD-CTS frame 52.

The other terminals (terminals 2 to n) receiving FD-RTS frame 51 having transmitted from terminal 1 determines that the frame is not destined for this terminal itself, on the basis of “RA” of FD-RTS frame 51. In this case, terminals 2 to n measure the reception power for FD-RTS frame 51, and calculate the path loss “P_{Loss(STA1→STAx)(x=2, 3, . . . , n)}” from terminal 1 to the own terminals, on the basis of the difference between the measured reception power and the transmission power for FD-RTS frame 51. In the case of terminal 2, this terminal calculates the path loss “P_{Loss(STA1→STA2)}”. Terminal 2 and the like store the calculated path loss in the buffer (e.g., the buffer in the controller, or buffer 36).

Terminal 2 and the like receive FD-CTS frame 52 transmitted from AP 11, SIFS-after receipt of FD-RTS frame 51. Terminal 2 and the like determine that the frame is not destined for the own terminal on the basis of “RA” of FD-CTS frame 52. In this case, terminal 2 or the like inspects whether the identification information on this terminal itself is set in “Control” field of FD-CTS frame 52. In this example, in this field, the identification information on terminal 2 is set but the identification information on the other terminals (terminals 3 to 10) is not set. Terminal 2 determines that this terminal is selected as the full-duplex downlink transmission destination. The terminals other than terminal 2 determine that the own terminals are not selected as the downlink transmission destination.

Terminal 2 measures the reception power for FD-CTS frame 52, and calculates the path loss “P_{Loss(AP→STA2)}” from AP 11 to terminal 2, on the basis of the difference between the measured reception power and the transmission power for FD-CTS frame 52. The information that specifies FD-CTS frame 52 may be described in “Control” field of FD-CTS frame 52, or the transmission power of FD-CTS frame 52 may be predetermined. Terminal 2 generates FD-CTS frame 53 where the calculated “P_{Loss(AP→STA2)}” and “P_{Loss(STA1→STA2)}” are set in “Control” field, and transmits FD-CTS frame 53 to AP 11 SIFS-after receipt of FD-CTS frame 52. That is, “RA” in FD-CTS frame 53 is the MAC address of AP 11. FD-CTS frame 53 is received by AP 11.

FD-CTS frame 53 can be received by another terminal. The other terminal determines that FD-CTS frame 53 is not destined for the own terminal, and discards the frame, for example. When terminal 1 receives FD-CTS frame 53, terminal 1 may identify that terminal 2 is the downlink transmission destination terminal of AP 11.

When AP 11 receives FD-CTS frame 53, AP 11 identifies path losses “P_{Loss(AP→STA2)}” and “P_{Loss(STA1→STA2)}” calculated by terminal 2, on the basis of “Control” field of the frame. AP 11 determines the transmission power to be used by AP 11 for downlink transmission in full duplex communication to terminal 2, on the basis of the transmission power used by terminal 1 for uplink transmission in full duplex communication, path losses “P_{Loss(AP→STA2)}” and “P_{Loss(STA1→STA2)}” of terminal 2, and Expression (5). For example, the inequality sign in Expression (5) is changed to the equality sign to generate the following Expression (6).

$${α}_{Required} = \frac{{P}_{DL @ AP} - {P}_{Loss ( AP -> STA 2 )}}{{P}_{UL @ STA 1} - {P}_{Loss ( STA 1 -> STA 2 )}} \qquad Expression ( 6 )$$

“α_{Required}”, “P_{Loss(AP→STA2)}” and “P_{Loss(STA1→STA2)}” and “P_{UL@STA1}” are substituted in Expression (6) to calculate “P_{DL@AP}”. The value is adopted as the lower limit value of downlink transmission power. AP 11 determines the calculated “P_{DL@AP}” or a larger value as the downlink transmission power. If the determined value exceeds the predetermined maximum allowable power, the maximum allowable power is adopted as the downlink transmission power.

Alternatively, in another example, AP 11 may determine the downlink transmission power in consideration of the self-interference. For example, the condition for downlink transmission power is determined so as to satisfy the reception quality (required SINR) required for uplink reception of AP 11, on the basis of the uplink transmission power for terminal 1, and the path loss “P_{Loss(STA1→AP)}” from terminal 1 to AP 11. For example, the uplink reception power is obtained by subtracting the path loss “P_{Loss(STA1→AP)}” from terminal 1 to AP 11, from the uplink transmission power in full duplex for terminal 1. The amount of interference is obtained by subtracting the self-interference canceling capability from the downlink transmission power, and then the downlink transmission power is determined so that the result obtained by subtracting the amount of interference from the uplink reception power can be at least the required SINR. Note that the downlink transmission power to be determined is determined in a range of satisfying the condition of Expression (5).

When the start time point of the full duplex duration notified in FD-CTS frame 52 is reached, terminal 1 uplink-transmits data frame 54 to AP 11 with the transmission power notified in FD-RTS frame 51. When the start time point of the full duplex duration is reached, AP 11 downlink-transmits data frame 55 to terminal 2 with the downlink transmission power determined as described above. That is, at the same time when AP 11 receives data frame 54 from terminal 1, AP 11 downlink-transmits data frame 55 to terminal 2. As described above, full duplex communication is performed.

Terminal 2 receives data frame 55 downlink-transmitted from AP 11. At the same time when terminal 2 receives data frame 55, terminal 2 receives the signal of data frame 54 from terminal 1 as the interference signal. However, data frame 55 has been transmitted with the transmission power that satisfies the required SINR for terminal 2. Consequently, terminal 2 can correctly receive data frame 55.

Subsequently, SIFS-after receipt of data frame 54, AP 11 downlink-transmits an acknowledgement response frame to terminal 1. SIFS-after receipt of data frame 55, terminal 2 uplink-transmits an acknowledgement response frame to AP 11. That is, the acknowledgement responses are full-duplex transmitted. In this case, inter-node interference from terminal 2 to terminal 1 can occur. The path loss from terminal 2 to terminal 1 is preliminarily calculated and notified to AP 11. AP 11 may use the path loss to determine the transmission power for the acknowledgement response frame to terminal 1. The method of determining the transmission power may be a method analogous to the method of determining the transmission power for the data frame to be downlink-transmitted to the terminal. Alternatively, the acknowledgement response frames may be transmitted not in full duplex communication but at timings different from each other. Examples of the acknowledgement response frames include “ACK” frame and “Block Ack” frame.

In the sequence of FIG. 8, terminal 2 calculates the path loss “P_{Loss(STA1→STA2)}” with terminal 1 using FD-RTS frame 51. Alternatively, before start of this sequence, terminal 2 may receive a frame from terminal 1 and calculate the path loss. Terminal 2 preliminarily stores the information that represents the calculated path loss in the buffer. When terminal 2 receives FD-CTS frame 52, terminal 2 may read the preliminarily calculated value of the path loss from the buffer, and sets the value in FD-CTS frame 53.

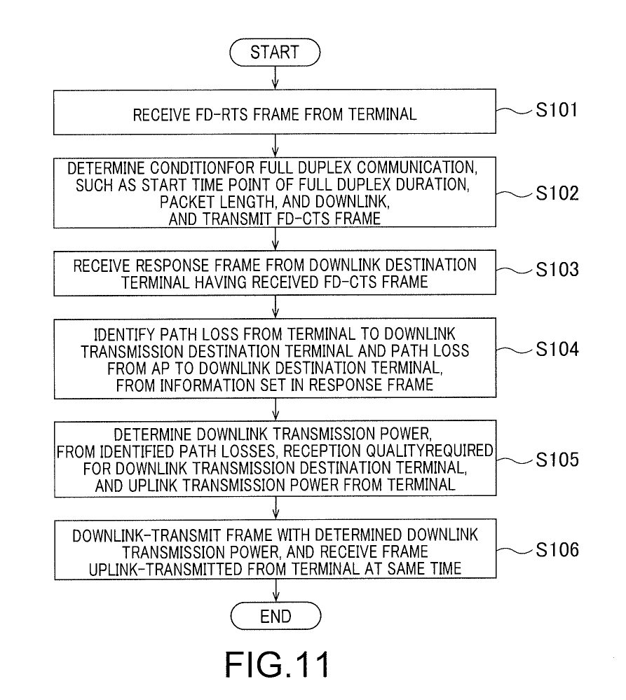

FIG. 11 is a flowchart of an operation of AP 11 according to this embodiment.

AP 11 receives FD-RTS frame 51 from the terminal (here terminal 1) (S101). In the FD-RTS frame, for example, flag information that represents a full-duplex uplink transmission request, information that specifies the transmission power used for full-duplex uplink transmission and the like are set.

AP 11 having received FD-RTS frame 51 determines the condition for full duplex communication, such as the start time point of full duplex duration, the packet length, and the downlink transmission destination terminal (here terminal 2), and transmits FD-CTS frame 52 where information representing the determined content is set in “Control” field (S102).

AP 11 receives the response frame (e.g., the FD-CTS frame) from terminal 1 having received FD-CTS frame 52 (S103). AP 11 identifies the path loss from terminal 1 to terminal 2 and the path loss from AP 11 to terminal 2, from the information set in the response frame (S104).

AP 11 determines the transmission power to be used for full-duplex downlink transmission, from the path loss from terminal 1 to terminal 2, the path loss from AP 11 to terminal 2, the reception quality required for downlink reception of terminal 2, and the transmission power to be used for uplink transmission from terminal 1 in full duplex communication (S105).

At the start time point of full duplex duration, AP 11 downlink-transmits the frame to terminal 2 with the determined transmission power, and receives the frame uplink-transmitted from terminal 1 at the same time (S106).

In this embodiment, AP 11 uses the path loss from the uplink transmission terminal to the downlink transmission destination terminal, and the path loss from AP 11 to the downlink transmission terminal to determine the downlink transmission power that allows the reception quality at the downlink transmission destination terminal to be at least the desired reception quality (e.g., the required SINR). AP 11 downlink-transmits the frame to the downlink transmission destination terminal with the determined transmission power. Accordingly, irrespective of the interference from the terminal that performs uplink transmission, the probability of successful frame reception at the downlink transmission terminal can be improved. Consequently, the throughput at the system that performs full duplex communication can be improved.

### Modification Example

During full duplex communication, terminal 2 can perform beamforming using multiple antennas. For example, there is beamforming that forms the directionality toward AP 11, and forms null toward terminal 2. In this case, the amount of interference to terminal 2 can be reduced. The amount of interference to terminal 2 or the path loss during such beamforming is preliminarily calculated. For example, terminal performs beamforming in full duplex communication in actuality, and terminal 2 calculates the amount of interference or the path loss in this case. The information specifying the calculated amount of interference or the path loss is notified to AP 11. Accordingly, AP 11 can adjust the downlink transmission power to terminal 2 to be lower while satisfying the required SINR for terminal 2. During full duplex communication, beamforming from AP 11 to terminal 2 may further be performed.

### Second Embodiment

In the sequence of the first embodiment, terminal 1 operates as the initiator of full duplex communication. In this embodiment, a sequence example in a case where AP 11 operates as the initiator of full duplex communication is described.

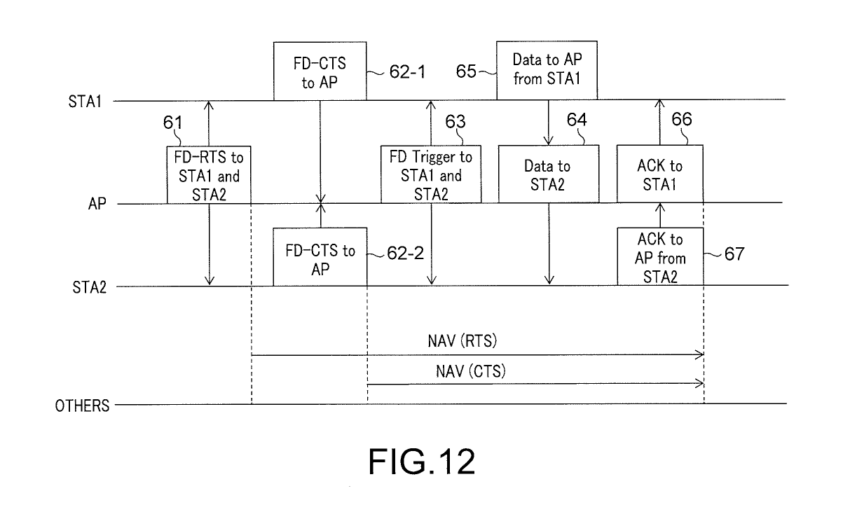

FIG. 12 shows an example of a frame sequence for full duplex communication according to this embodiment. The same description as that of the first embodiment is appropriately omitted. It is assumed that the path loss “P_{Loss(STA1→STA2)}” from terminal 1 to terminal 2, and the path loss “P_{Loss(STA2→STA1)}” from terminal 2 to terminal 1 are preliminarily measured. Information that represents the path losses is stored in the buffers of terminals 1 and 2.

When AP 11 determines to perform full duplex communication between terminals 1 and 2, AP 11 broadcasts FD-RTS frame 61. That is, “RA” of FD-RTS frame 61 is the broadcast address. For example, flag information that represents start of full duplex communication, and information (AID etc.) that designates terminals 1 and 2 are set in “Control” field of FD-RTS frame 61. Here, the FD-RTS frame is broadcast. Alternatively, according to another method, multiple FD-RTS frames may be DL (DownLink)-MU (Multi-User)-transmitted to terminals 1 and 2. An example of DL-MU transmission may be DL-OFDMA (Orthogonal Frequency Division Multiple Access), DL-MU-MIMO (Multi-User Multi-Input Multi-Output) or the like.

OFDMA is a scheme that allocates Resource Unit (RU) that contains one or more subcarriers to the terminals, and simultaneously performs transmission and reception between AP and the multiple terminals on the resource unit basis. Uplink OFDMA is represented as UL-OFDMA. Downlink OFDMA is represented as DL-OFDMA. DL-MU-MIMO is a scheme that uses a technique referred to as beamforming to form beams spatially orthogonal to each other for the multiple terminal, and performs transmission.

Each of terminals 1 and 2 receives FD-RTS frame 61, and verifies “Control” field to detect that the own terminal is designated. Each of terminals 1 and 2 identifies the designated terminal other than the own terminal. For example, terminal 1 identifies that terminal 2 is designated. Terminal 1 generates FD-CTS frame 62-1 (see FIG. 10) where information specifying the path loss “P_{Loss(STA2→STA1)}” from terminal 2 to the own terminal is set in “Control” field. Terminal 2 generates FD-CTS frame 62-2 where information specifying the path loss “P_{Loss(STA1→STA2)}” from terminal 1 to the own terminal is set in “Control” field. In “Control” field, other information may be additionally set. The other information is information that represents presence or absence of an uplink transmission request, the state of the content of the buffer that stores therein data for uplink transmission, the length of the packet intended to be uplink-transmitted or the like. Terminals 1 and 2 UL (UpLink)-MU-transmits FD-CTS frames 62-1 and 62-2 to AP 11. Examples of UL-MU transmission include UL-OFDMA, UL-MU-MIMO, etc. UL-MU-MIMO is a scheme that allows multiple terminals to transmit frames in a spatially multiplexed manner at the same timing. Alternatively, another method may allow terminals 1 and 2 to unicast-transmit FD-CTS frames 62-1 and 62-2 sequentially. In this case, the transmission order may be specified in “Control” field of FD-RTS frame 61.

AP 11 receives FD-CTS frames 62-1 and 62-2 from terminals 1 and 2. AP 11 determines that the terminal (uplink transmission terminal) serving as a target allowed to perform uplink transmission is terminal 1, and the terminal (downlink transmission destination terminal) serving as a downlink transmission destination is terminal 2. It may be determined which terminals are designated as the uplink transmission terminal and the downlink transmission terminal, according to a predetermined scheduling method. For example, in a case where the FD-RTS frame contains the information on presence or absence of an uplink transmission request, the information may be used for the determination. AP 11 determines the full-duplex packet length (corresponding to the length of full duplex duration), the transmission power which terminal 1 is allowed to use for uplink transmission, and the transmission power used for downlink transmission for terminal 2.

An example of determining the transmission powers is described as follows. AP 11 detects path losses “P_{Loss(STA2→STA1)}” and “P_{Loss(STA1→STA2)}” from “Control” field of FD-CTS frames 62-1 and 62-2. AP 11 determines full-duplex uplink transmission power “P_{UL@STA1}” from terminal 1 to AP 11, and downlink transmission power “P_{DL@AP}” from AP 11 to terminal 2, on the basis of the path losses and the required SINR for terminal 2. This determination is made so as to satisfy Expression (5) in a manner analogous to that in the first embodiment. In a case where any one is preliminarily determined, the other may be determined according to the relationship of Expression (5). For example, in a case where the downlink transmission power value is preliminarily determined, the downlink transmission power is fixed to this value, and the uplink transmission power is determined. When the determined uplink transmission power exceeds the predetermined maximum allowable power, the uplink transmission power is limited to a value equal to or less than the maximum allowable power. As with the first embodiment, downlink transmission power “P_{DL@AP}” may be determined in consideration of the self-interference at AP 11.

AP 11 generates an FD trigger frame in which information, such as the identification information on terminal 1 allowed to perform uplink transmission, the uplink transmission power, the identification information on terminal 2 serving as the downlink transmission destination, and the full-duplex packet length, is set. AP 11 broadcasts the FD trigger frame, a certain time period (e.g., SIFS) after completion of receiving CTS frames 62-1 and 62-2.

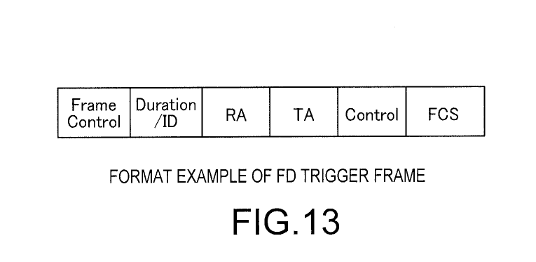

FIG. 13 shows a format example of the FD trigger frame. The FD trigger frame has a role as a trigger for starting full duplex communication.

The information that specifies the packet length, the identification information on and the uplink transmission power of terminal 1, and the identification information on terminal 2 are set in “Control” field. Information other than these pieces of information may be additionally set. For example, information that specifies MCS used in full-duplex uplink or downlink transmission may be set. Information on the start time point of the full duplex duration, and information that specifies the downlink transmission power to terminal 2 may be set.

In a case where the uplink transmission power is preliminarily determined and is recognized by terminal 1, the information that specifies the uplink transmission power is not necessarily set. The transmission destination of the FD trigger frame may only be terminal 1, and transmission of the FD trigger frame to terminal 2 serving as the downlink transmission destination may be omitted. In this case, setting of the information pertaining to terminal 2 in “Control” field may be omitted.

The broadcast address is set in “RA” field. In “TA” field, the MAC address of AP 11 is set. A value for specifying the FD trigger frame is set in “Type” and “Subtype” in “Frame Control” field. For example, the value that specifies the duration to the end of the full duplex duration in “Duration/ID” field is set. This setting allows another terminal having received the FD trigger frame to set NAV during full duplex communication (NAV is set by receipt of FD-RTS frame 61, or FD-CTS frame 62-1, or FD-CTS frame 62-2, and NAV is continuously maintained for the terminal).

AP 11 downlink-transmits data frame 64 to terminal 2 a certain time period (e.g., SIFS) after completion of transmitting FD trigger frame 63, with the transmission power as described above. More specifically, AP 11 generates the packet that contains data frame 64 having the packet length determined as described above, and transmits the generated packet. Terminal 1 uplink-transmits data frame 65 a certain time period after completion of receiving FD trigger frame 63, with the transmission power designated in FD trigger frame 63. More specifically, terminal 1 generates the packet that contains data frame 65 having the packet length identified in FD trigger frame 63, and transmits the generated packet. When the packet to be generated has a packet length less than the designated packet length, padding data may be added to the end of the packet to cause the length of the generated packet to coincide with the designated packet length. Accordingly, full duplex communication that includes uplink transmission from terminal 1 to AP 11 and downlink transmission from AP11 to terminal 2 can be achieved, with the reception quality (required SINR) of terminal 2 being secured. That is, terminal 2 can correctly receive data frame 64. In the case where the start time point of the full duplex duration is set in FD trigger frame 63, AP 11 and terminal 1 transmit data frames 64 and 65 at the start time point.

AP 11 downlink-transmits acknowledgement response frame 66 to terminal 1 a certain time period (e.g., SIFS) after completion of receiving data frame 65. Terminal 2 uplink-transmits acknowledgement response frame 67 to AP 11 a certain time period (e.g., SIFS) after completion of receiving data frame 64. AP 11 may control the transmission powers of acknowledgement response frames 66 and 67 in consideration of the inter-node interference from terminal 2 to terminal 1. In this case, AP 11 sets, in FD trigger frame 63, information that specifies the transmission power to be used by terminal 2 to transmit acknowledgement response frame 66. The transmission powers of acknowledgement response frames 66 and 67 may be determined by AP 11 in a manner analogous to that in the first embodiment. In order to cause the lengths of acknowledgement response frames 66 and 67 to coincide with each other, the information that specifies the length (more specifically, the packet length) of acknowledgement response frame 67 may be set in “Control” field of FD trigger frame 63. Acknowledgement response frames 66 and 67 may be “ACK” frames, “BA” (Block ACK) frames, or “Multi-Station BA” frames.

In this embodiment, even in a case where AP 11 becomes the initiator of full duplex communication, the throughput of the system that performs full duplex communication can be improved by setting the power of transmission to the terminal serving as the downlink transmission destination so as to satisfy the required SINR of the terminal.

### Third Embodiment

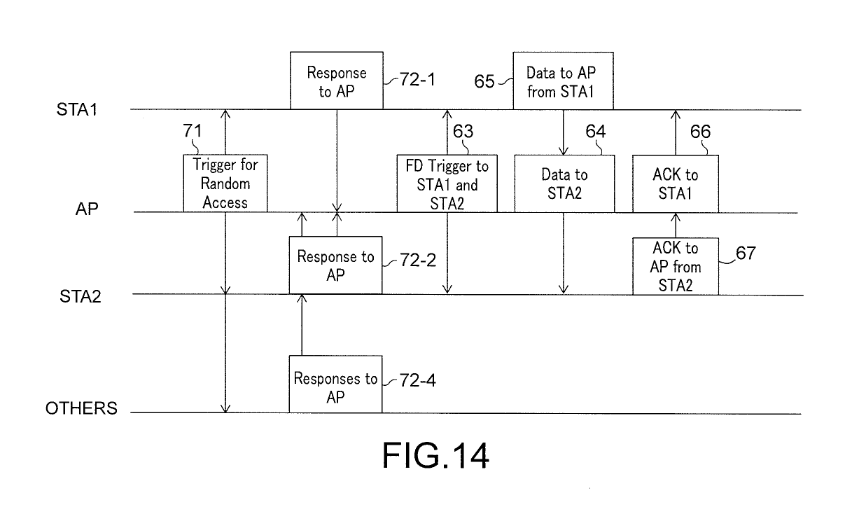

FIG. 14 shows an example of a frame sequence for full duplex communication according to this embodiment. The difference from the sequence in FIG. 12 in the second embodiment resides in that AP 11 uses UL-OFDMA through random access to obtain the information on the uplink transmission request issued by the terminal, and the information on the path loss at the terminal from another terminal. In UL-OFDMA through random access, AP 11 transmits the frames at the same time a certain time period after receipt of the trigger frame using Resource Units (RUs) randomly selected by multiple terminals from among RUs designated in the trigger frame. The sequence after the operation of transmitting the FD trigger frame 63 to terminals 1 and 2 is the same as that in FIG. 12. Consequently, the description thereof is omitted.

AP 11 transmits a trigger frame (TF-R) 71 for random access on the basis of the access right to the wireless medium obtained through carrier sensing and random backoff. TF-R 71 contains, for example, “Frame Control” field, “Duration/ID” field, “RA” field, “TA” field, “Control” field, and “FCS” field. Identification information on multiple Resource Units (RUs) usable in UL-OFDMA is set in “Control” field. “RA” is, for example, a broadcast address or a multi-cast address.

Terminals 1 and 2 and the other terminals receive TF-R 71. In a case where uplink transmission is desired, the terminal having received TF-R 71 transmits a notification frame as a response to TF-R 71. “Type” in “Frame Control” field in the notification frame may be any of data, management, and control. The terminal includes parameter information, such as information that specifies the path loss from another terminal, and the type and amount of data in the buffer in the own terminal, in the notification frame. Another example of the parameter information is at least one of the presence or absence of desire for uplink transmission, the length of the packet desired for uplink transmission, and the identification information on the own terminal. The terminal randomly selects at least one RU from among multiple RUs designated by TF-R 71, and transmits the notification frame to AP 11 a certain time period (e.g., SIFS) after completion of receiving TF-R 71 in the selected RU. RA in the notification frame is, for example, the MAC address of AP 11. It is herein assumed that notification frames 72-1, 72-2, . . . , 72-n are transmitted from terminals 1 to n. Here, it is assumed that terminals 1, 2 and 4 use different RUs while each combination of two or more terminals among other terminals 3 and 5 to n shares the same RU. As a result, it is assumed that AP 11 succeeds in receiving the notification frames transmitted from terminals 1, 2 and 4 while failing in receiving the notification frames transmitted from terminals 3, 5 to n owing to frame collision.

AP 11 selects a terminal caused to perform uplink transmission, from among terminals 1, 2 and 4. Here, terminal 1 is selected. AP 11 selects a terminal serving as the downlink transmission destination. The downlink transmission destination terminal is not necessarily selected from the terminals having transmitted the notification frames. The sequence thereafter is analogous to the sequence in FIG. 12. Consequently, the description thereof is omitted.

According to this embodiment, UL-OFDMA through random access is used to collect, from each terminal, presence or absence of the request for uplink transmission. Consequently, information on the terminal intended to perform uplink transmission, and information on the path loss pertaining to the terminal can be effectively collected.

### Fourth Embodiment

In the above embodiments, the number of terminals that perform full-duplex uplink transmission is one. A configuration where multiple terminals simultaneously perform full-duplex uplink transmission (UL (Uplink)-MU (Multi-User) transmission) may be adopted. In the above embodiments, the number of terminals that perform full-duplex downlink transmission is one. A configuration where multiple terminals simultaneously perform full-duplex downlink transmission (DL-MU transmission) may be adopted.

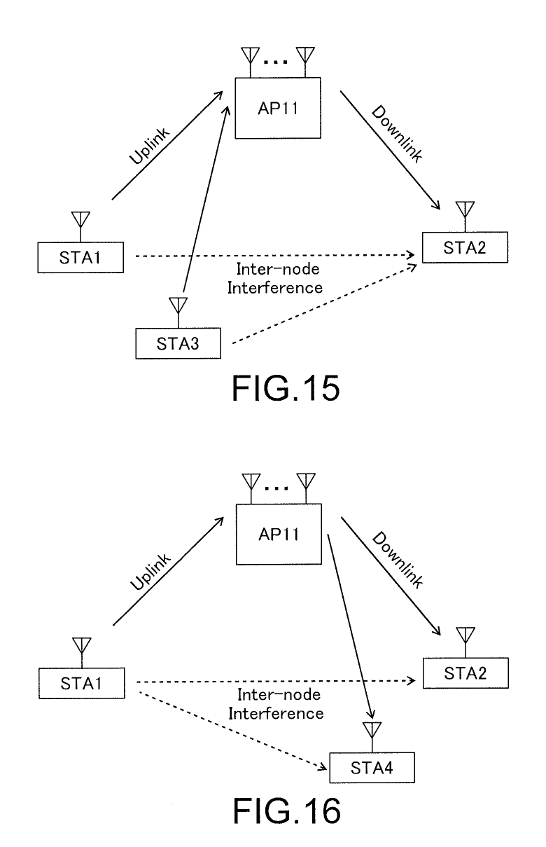

FIG. 15 shows an example where multiple terminals simultaneously perform uplink transmission (UL-MU transmission) in full duplex communication. Terminals 1 and 3 UL-MU-transmit frames to AP 11. At the same time, AP 11 downlink-transmits a frame to terminal 2. The UL-MU scheme may be, for example, UL-OFDMA, or UL-MU-MIMO. The frequency band used for UL-MU transmission is the same as the frequency band used for downlink transmission. In this case, terminal 2 is affected by inter-node interference from each of terminals 1 and 3. Terminal 2 calculates the path losses of terminals 1 and 3 on the basis of the frames received from terminals 1 and 3 before full-duplex communication, and notifies the information representing the calculated path loss to AP 11. AP 11 determines the downlink transmission power to terminal 2, and the uplink transmission powers from terminals 1 and 3, on the basis of the notified path losses. The determination method may use a term (P_{UL@STA3}−P_{Loss(STA3→STA2)}) obtained by subtracting path loss “P_{Loss(STA3→STA2)}” from the transmission power value for terminal 3, as the denominator of the right-hand side of Expression (5) in the first embodiment. According to a method analogous to the methods of the above embodiments, the downlink transmission power to terminal 2, or the uplink transmission powers from terminals 1 and 3, or both of these powers may be calculated. Here, the number of terminals that perform uplink transmission is two. Cases where the number is three or more are analogous thereto.

Also in the example in FIG. 15, beamforming that forms null from terminals 1 and 3 to terminal 2 may be performed as with the modification example of the first embodiment. In this case, for example, a combination of beams from terminals 1 and 3 is configured to be null toward terminal 2. To achieve this, sounding is performed for the downlink channel from terminals 1 and 3 to terminal 2. For example, known signals are transmitted from terminals 1 and 3 to terminal 2. Terminal 2 estimates the downlink channels on the basis of the known signals, and feeds back the estimated channel information to terminals 1 and 3. Terminals 1 and 3 cooperate to determine the beamforming parameter, from the fed back channel information (sounding result).

FIG. 16 shows an example where AP 11 simultaneously performs downlink transmission (DL-MU transmission) in full duplex communication to the multiple terminals. Terminal 1 uplink-transmits a frame to AP 11. At the same time, AP 11 DL-MU-transmits frames to terminals 2 and 4. The DL-MU scheme may be, for example, DL-OFDMA, or DL-MU-MIMO. The frequency band used for uplink transmission is the same as the frequency band used for DL-MU transmission. Terminals 2 and 4 are affected by inter-node interference from terminal 1. Terminals 2 and 4 calculate the path losses with terminal 1 on the basis of the frame received from terminal 1 before full-duplex communication, and notify the information representing the calculated path losses to AP 11. AP 11 determines the downlink transmission powers to terminals 2 and 4, and the uplink transmission power from terminal 1, on the basis of the notified path losses. The downlink transmission powers to terminals 2 and 4 are calculated by separately performing calculation analogous to that of the above embodiments for each of terminals 2 and 4. Here, the number of terminals that perform downlink transmission is two. Cases where the number is three or more are analogous thereto. As with the above embodiments, downlink transmission power and the uplink transmission power may be determined in consideration of the self-interference at AP 11. In this case, it can be considered that a part of the combination of the transmission signals to terminals 2 and 4 is leaked as an interference signal toward the receiver.

### Fifth Embodiment

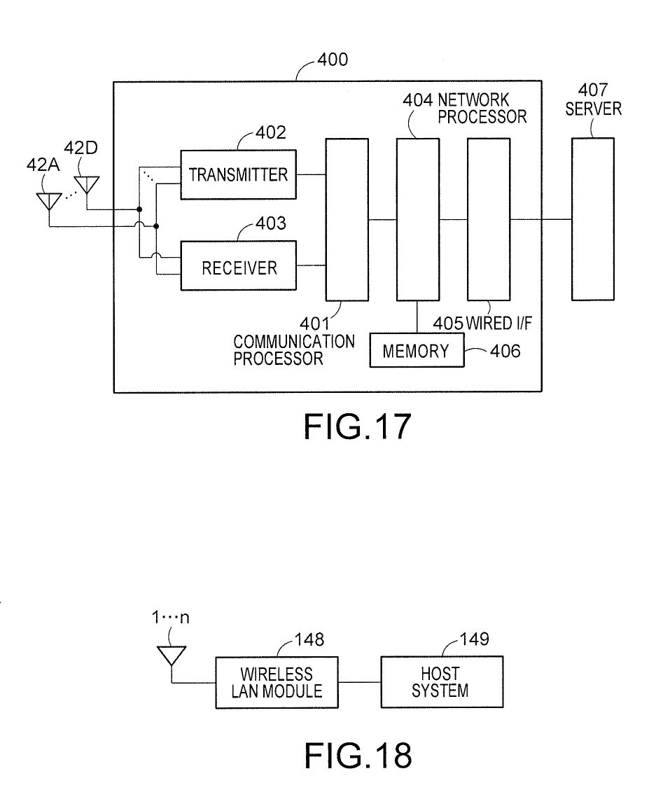

FIG. 17 is a functional block diagram of a base station (access point) 400 according to the second embodiment. The access point includes a communication processor 401, a transmitter 402, a receiver 403, antennas 42A, 42B, 42C, and 42D, a network processor 404, a wired I/F 405, and a memory 406. The access point 400 is connected to a server 407 through the wired I/F 405. At least a former of the communication processor 401 and the network processor 404 has functions similar to the controller or the controlling circuitry in the first embodiment. The transmitter 402 and the receiver 403 have functions similar to the transmitter and the receiver described in the first embodiment. Alternatively, the transmitter 402 and the receiver 403 may perform analog domain processing in the transmitter and the receiver and the network processor 404 may perform digital domain processing in the transmitter and the receiver in the first embodiment. The communication processor 404 has functions similar to the upper layer processor. The communication processor 401 may internally possess a buffer for transferring data to and from the network processor 404. The buffer may be a volatile memory, such as an SRAM or a DRAM, or may be a non-volatile memory, such as a NAND or an MRAM.

The network processor 404 controls data exchange with the communication processor 401, data writing and reading to and from the memory 406, and communication with the server 407 through the wired I/F 405. The network processor 404 may execute a higher communication process of the MAC layer, such as TCP/IP or UDP/IP, or a process of the application layer. The operation of the network processor may be performed through processing of software (program) by a processor, such as a CPU. The operation may be performed by hardware or may be performed by both of the software and the hardware.

For example, the communication processor 401 corresponds to a baseband integrated circuit, and the transmitter 402 and the receiver 403 correspond to an RF integrated circuit that transmits and receives frames. The communication processor 401 and the network processor 404 may be formed by one integrated circuit (one chip). Parts that execute processing of digital areas of the transmitter 402 and the receiver 403 and parts that execute processing of analog areas may be formed by different chips. The communication processor 401 may execute a higher communication process of the MAC layer, such as TCP/IP or UDP/IP. Although the number of antennas is four here, it is only necessary that at least one antenna is included.

The memory 406 saves data received from the server 407 and data received by the receiver 402. The memory 406 may be, for example, a volatile memory, such as a DRAM, or may be a non-volatile memory, such as a NAND or an MRAM. The memory 406 may be an SSD, an HDD, an SD card, an eMMC, or the like. The memory 406 may be provided outside of the base station 400.

The wired I/F 405 transmits and receives data to and from the server 407. Although the communication with the server 407 is performed through a wire in the present embodiment, the communication with the server 407 may be performed wirelessly.

The server 407 is a communication device that returns a response including requested data in response to reception of a data forward request for requesting transmission of the data. Examples of the server 407 include an HTTP server (Web server) and an FTP server. However, the server 407 is not limited to these as long as the server 407 has a function of returning the requested data. The server 407 may be a communication device operated by the user, such as a PC or a smartphone. The server 407 may wirelessly communicate with the base station 400.

When the STA belonging to the BSS of the base station 400 issues a forward request of data for the server 407, a packet regarding the data forward request is transmitted to the base station 400. The base station 400 receives the packet through the antennas 42A to 42D. The base station 400 causes the receiver 403 to execute the process of the physical layer and the like and causes the communication processor 401 to execute the process of the MAC layer and the like.

The network processor 404 analyzes the packet received from the communication processor 401. Specifically, the network processor 404 checks the destination IP address, the destination port number, and the like. When the data of the packet is a data forward request such as an HTTP GET request, the network processor 404 checks whether the data requested by the data forward request (for example, data in the URL requested by the HTTP GET request) is cached (stored) in the memory 406. A table associating the URL (or reduced expression of the URL, such as a hash value or an identifier substituting the URL) and the data is stored in the memory 406. The fact that the data is cached in the memory 406 will be expressed that the cache data exists in the memory 406.

When the cache data does not exist in the memory 406, the network processor 404 transmits the data forward request to the server 407 through the wired I/F 405. In other words, the network processor 404 substitutes the STA to transmit the data forward request to the server 407. Specifically, the network processor 404 generates an HTTP request and executes protocol processing, such as adding the TCP/IP header, to transfer the packet to the wired I/F 405. The wired I/F 405 transmits the received packet to the server 407.

The wired I/F 405 receives, from the server 407, a packet that is a response to the data forward request. From the IP header of the packet received through the wired I/F 405, the network processor 404 figures out that the packet is addressed to the STA and transfers the packet to the communication processor 401. The communication processor 401 executes processing of the MAC layer and the like for the packet. The transmitter 402 executes processing of the physical layer and the like and transmits the packet addressed to the STA from the antennas 42A to 42D. The network processor 404 associates the data received from the server 407 with the URL (or reduced expression of the URL) and saves the cache data in the memory 406.

When the cache data exists in the memory 406, the network processor 404 reads the data requested by the data forward request from the memory 406 and transmits the data to the communication processor 401. Specifically, the network processor 404 adds the HTTP header or the like to the data read from the memory 406 and executes protocol processing, such as adding the TCP/IP header, to transmit the packet to the communication processor 401. In this case, the transmitter IP address of the packet is set to the same IP address as the server, and the transmitter port number is also set to the same port number as the server (destination port number of the packet transmitted by the communication terminal), for example. Therefore, it can be viewed from the STA as if communication with the server 407 is established. The communication processor 401 executes processing of the MAC layer and the like for the packet. The transmitter 402 executes processing of the physical layer and the like and transmits the packet addressed to the STA from the antennas 42A to 42D.

According to the operation, frequently accessed data is responded based on the cache data saved in the memory 406, and the traffic between the server 407 and the base station 400 can be reduced. Note that the operation of the network processor 404 is not limited to the operation of the present embodiment. There is no problem in performing other operation when a general caching proxy is used, in which data is acquired from the server 407 in place of the STA, the data is cached in the memory 406, and a response is made from the cache data of the memory 406 for a data forward request of the same data.

The base station (access point) according to the present invention can be applied for the base station in the above-stated any embodiment. The transmission of the frame, the data or the packet used in the any embodiment may be carried out based on the cached data stored in the memory 406. Also, information obtained based on the frame, the data or the packet received by the base station in the first to seventh embodiments may be cached in the memory 406. The frame transmitted by the base station in the first to seventh embodiments may include the cached data or information based on the cached data. The information based on the cached data may include information on a size of the data, a size of a packet required for transmission of the data. The information based on the cached data may include a modulation scheme required for transmission of the data. The information based on the cached data may include information on existence or non-existence of data addressed to the terminal,

The base station (access point) according to the present invention can be applied for the base station in the above-stated any embodiment. In the present embodiment, although the base station with the cache function is described, a terminal (STA) with the cache function can also be realized by the same block configuration as FIG. 17. In this case, the wired I/F 405 may be omitted. The transmission, by the terminal, of the frame, the data or the packet used in the any embodiment may be carried out based on the cached data stored in the memory 406. Also, information obtained based on the frame, the data or the packet received by the terminal in the any embodiment may be cached in the memory 406. The frame transmitted by the terminal in the first embodiment may include the cached data or information based on the cached data. The information based on the cached data may include information on a size of the data, a size of a packet required for transmission of the data. The information based on the cached data may include a modulation scheme required for transmission of the data. The information based on the cached data may include information on existence or non-existence of data addressed to the terminal.

### Sixth Embodiment

FIG. 18 shows an example of entire configuration of a terminal (WLAN terminal) or a base station. The example of configuration is just an example, and the present embodiment is not limited to this. The terminal or the base station includes one or a plurality of antennas 1 to n (n is an integer equal to or greater than 1), a wireless LAN module 148, and a host system 149. The wireless LAN module 148 corresponds to the wireless communication device according to the first embodiment. The wireless LAN module 148 includes a host interface and is connected to the host system 149 through the host interface. Other than the connection to the host system 149 through the connection cable, the wireless LAN module 148 may be directly connected to the host system 149. The wireless LAN module 148 can be mounted on a substrate by soldering or the like and can be connected to the host system 149 through wiring of the substrate. The host system 149 uses the wireless LAN module 148 and the antennas 1 to n to communicate with external apparatuses according to an arbitrary communication protocol. The communication protocol may include the TCP/IP and a protocol of a layer higher than that. Alternatively, the TCP/IP may be mounted on the wireless LAN module 148, and the host system 149 may execute only a protocol in a layer higher than that. In this case, the configuration of the host system 149 can be simplified. Examples of the present terminal include a mobile terminal, a TV, a digital camera, a wearable device, a tablet, a smartphone, a game device, a network storage device, a monitor, a digital audio player, a Web camera, a video camera, a projector, a navigation system, an external adaptor, an internal adaptor, a set top box, a gateway, a printer server, a mobile access point, a router, an enterprise/service provider access point, a portable device, a hand-held device, a vehicle and so on.

The wireless LAN module 148 (or the wireless communication device) may have functions of other wireless communication standards such as LTE (Long Term Evolution), LTE-Advanced (standards for mobile phones) as well as the IEEE802.11.

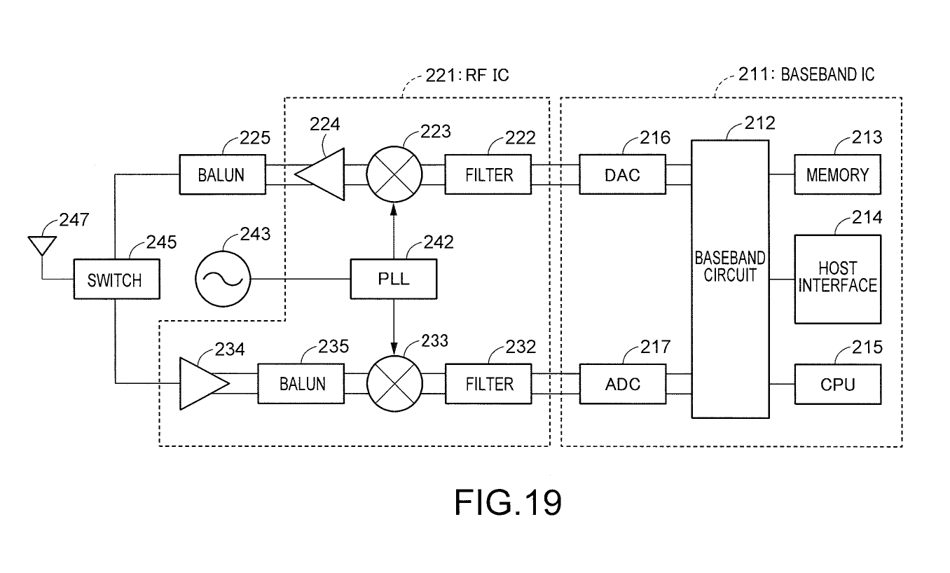

FIG. 19 shows an example of hardware configuration of a WLAN module. The configuration shown in the figure may be applied for each case in where the wireless communication device is mounted in non-AP terminal or in AP (Access Point) provided correspondingly to each function. That is, the configuration can be applied as specific examples of the wireless communication device as described in the above-stated any embodiment. In the configuration shown in figure, at least one antenna 247 is included although a plurality of antennas are included. In this case, a plurality of sets of a transmission system (216 and 222 to 225), a reception system (217, 232 to 235), a PLL 242, a crystal oscillator (reference signal source) 243, and a switch 245 may be arranged according to the antennas, and each set may be connected to a control circuit 212. One or both of the PLL 242 and the crystal oscillator 243 correspond to an oscillator according to the present embodiment.

The wireless LAN module (wireless communication device) includes a baseband IC (Integrated Circuit) 211, an RF (Radio Frequency) IC 221, a balun 225, the switch 245, and the antenna 247.

The baseband IC 211 includes the baseband circuit (control circuit) 212, a memory 213, a host interface 214, a CPU 215, a DAC (Digital to Analog Converter) 216, and an ADC (Analog to Digital Converter) 217.

The baseband IC 211 and the RF IC 221 may be formed on the same substrate. The baseband IC 211 and the RF IC 221 may be formed by one chip. Both or one of the DAC 216 and the ADC 217 may be arranged on the RF IC 221 or may be arranged on another IC. Both or one of the memory 213 and the CPU 215 may be arranged on an IC other than the baseband IC.

The memory 213 stores data to be transferred to and from the host system. The memory 213 also stores one or both of information to be transmitted to the terminal or the base station and information transmitted from the terminal or the base station. The memory 213 may also store a program required for the execution of the CPU 215 and may be used as a work area for the CPU 215 to execute the program. The memory 213 may be a volatile memory, such as an SRAM or a DRAM, or may be a non-volatile memory, such as a NAND or an MRAM.

The host interface 214 is an interface for connection to the host system. The interface can be anything, such as UART, SPI, SDIO, USB, or PCI Express.

The CPU 215 is a processor that executes a program to control the baseband circuit 212. The baseband circuit 212 mainly executes a process of the MAC layer and a process of the physical layer. One or both of the baseband circuit 212 and the CPU 215 correspond to the communication control apparatus that controls communication, the controller that controls communication, or controlling circuitry that controls communication.

At least one of the baseband circuit 212 or the CPU 215 may include a clock generator that generates a clock and may manage internal time by the clock generated by the clock generator.

For the process of the physical layer, the baseband circuit 212 performs addition of the physical header, coding, encryption, modulation process (which may include MIMO modulation), and the like of the frame to be transmitted and generates, for example, two types of digital baseband signals (hereinafter, “digital I signal” and “digital Q signal”).

The DAC 216 performs DA conversion of signals input from the baseband circuit 212. More specifically, the DAC 216 converts the digital I signal to an analog I signal and converts the digital Q signal to an analog Q signal. Note that a single system signal may be transmitted without performing quadrature modulation. When a plurality of antennas are included, and single system or multi-system transmission signals equivalent to the number of antennas are to be distributed and transmitted, the number of provided DACs and the like may correspond to the number of antennas.

The RF IC 221 is, for example, one or both of an RF analog IC and a high frequency IC. The RF IC 221 includes a filter 222, a mixer 223, a preamplifier (PA) 224, the PLL (Phase Locked Loop) 242, a low noise amplifier (LNA) 234, a balun 235, a mixer 233, and a filter 232. Some of the elements may be arranged on the baseband IC 211 or another IC. The filters 222 and 232 may be bandpass filters or low pass filters.

The filter 222 extracts a signal of a desired band from each of the analog I signal and the analog Q signal input from the DAC 216. The PLL 242 uses an oscillation signal input from the crystal oscillator 243 and performs one or both of division and multiplication of the oscillation signal to thereby generate a signal at a certain frequency synchronized with the phase of the input signal. Note that the PLL 242 includes a VCO (Voltage Controlled Oscillator) and uses the VCO to perform feedback control based on the oscillation signal input from the crystal oscillator 243 to thereby obtain the signal at the certain frequency. The generated signal at the certain frequency is input to the mixer 223 and the mixer 233. The PLL 242 is equivalent to an example of an oscillator that generates a signal at a certain frequency.

The mixer 223 uses the signal at the certain frequency supplied from the PLL 242 to up-convert the analog I signal and the analog Q signal passed through the filter 222 into a radio frequency. The preamplifier (PA) amplifies the analog I signal and the analog Q signal at the radio frequency generated by the mixer 223, up to desired output power. The balun 225 is a converter for converting a balanced signal (differential signal) to an unbalanced signal (single-ended signal). Although the balanced signal is handled by the RF IC 221, the unbalanced signal is handled from the output of the RF IC 221 to the antenna 247. Therefore, the balun 225 performs the signal conversions.

The switch 245 is connected to the balun 225 on the transmission side during the transmission and is connected to the LNA 234 or the RF IC 221 on the reception side during the reception. The baseband IC 211 or the RF IC 221 may control the switch 245. There may be another circuit that controls the switch 245, and the circuit may control the switch 245.

The analog I signal and the analog Q signal at the radio frequency amplified by the preamplifier 224 are subjected to balanced-unbalanced conversion by the balun 225 and are then emitted as radio waves to the space from the antenna 247.

The antenna 247 may be a chip antenna, may be an antenna formed by wiring on a printed circuit board, or may be an antenna formed by using a linear conductive element.

The LNA 234 in the RF IC 221 amplifies a signal received from the antenna 247 through the switch 245 up to a level that allows demodulation, while maintaining the noise low. The balun 235 performs unbalanced-balanced conversion of the signal amplified by the low noise amplifier (LNA) 234. The mixer 233 uses the signal at the certain frequency input from the PLL 242 to down-convert, to a baseband, the reception signal converted to a balanced signal by the balun 235. More specifically, the mixer 233 includes a unit that generates carrier waves shifted by a phase of 90 degrees based on the signal at the certain frequency input from the PLL 242. The mixer 233 uses the carrier waves shifted by a phase of 90 degrees to perform quadrature demodulation of the reception signal converted by the balun 235 and generates an I (In-phase) signal with the same phase as the reception signal and a Q (Quad-phase) signal with the phase delayed by 90 degrees. The filter 232 extracts signals with desired frequency components from the I signal and the Q signal. Gains of the I signal and the Q signal extracted by the filter 232 are adjusted, and the I signal and the Q signal are output from the RF IC 221.

The ADC 217 in the baseband IC 211 performs AD conversion of the input signal from the RF IC 221. More specifically, the ADC 217 converts the I signal to a digital I signal and converts the Q signal to a digital Q signal. Note that a single system signal may be received without performing quadrature demodulation.

When a plurality of antennas are provided, the number of provided ADCs may correspond to the number of antennas. Based on the digital I signal and the digital Q signal, the baseband circuit 212 executes a process of the physical layer and the like, such as demodulation process, error correcting code process, and process of physical header, and obtains a frame. The baseband circuit 212 applies a process of the MAC layer to the frame. Note that the baseband circuit 212 may be configured to execute a process of TCP/IP when the TCP/IP is implemented.

Processing of the self-interference canceller 24 and the controller 25 in FIG. 6 is carried out in the baseband circuit 212 as one example. A circuit performing functions of the self-interference canceller 24 may be arranged in the RF IC 221 side. The antenna 247 may be a directivity variable antenna. In this case, a switching control of the directivity pattern may be performed by the baseband circuit 212, CPU 215 or the like.

### Seventh Embodiment

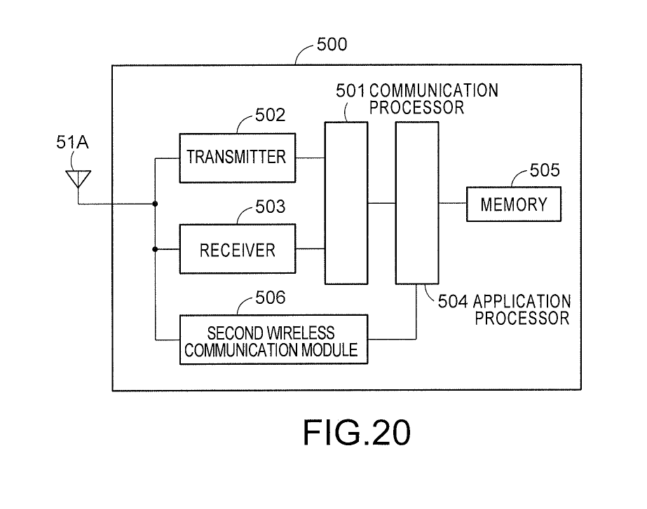

FIG. 20 is a functional block diagram of the terminal (STA) 500 according to a fourth embodiment. The STA 500 includes a communication processor 501, a transmitter 502, a receiver 503, an antenna 51A, an application processor 504 a memory 505, and a second wireless communication module 506. The base station (AP) may have the similar configuration.

The communication processor 501 has the functions similar to the controller as described in the first embodiment. The transmitter 502 and the receiver 503 have the functions similar to the transmitter and the receiver as described in the first embodiment. The transmitter 502 and the receiver 503 may perform analog domain processing in the transmitter and the receiver as described in the first embodiment and the communication processor 501 may perform digital domain processing in the transmitter and the receiver as described in the first embodiment. The communication processor 501 may internally possess a buffer for transferring data to and from the application processor 504. The buffer may be a volatile memory, such as an SRAM or a DRAM, or may be a non-volatile memory, such as a NAND or an MRAM.

The application processor 504 performs wireless communication through the communication processor 501, data writing or reading with the memory 505 and wireless communication through the second wireless communication module 506. The application processor 504 performs various processing such as Web browsing or multimedia processing of video or music or the like. The operation of application processor 504 may be carried out by software (program) processing by a processor such as CPU, by hardware, or both of them.

The memory 505 saves data received at the receiver 503 or the second wireless communication module 506, or data processed by the application processor 504. The memory 505 may be a volatile memory such as a DRAM or may be a non-volatile memory, such as a NAND or an MRAM. The memory 505 may be an SSD, an HDD, an SD card, or an eMMC or the like. The memory 505 may be arranged out of the access point 500.

The second wireless communication module 506 has the similar configuration to the WLAN module as shown in FIG. 18 or FIG. 19 as one example. The second wireless communication module 506 performs wireless communication in a different manner than that realized by the communication processor 501, the transmitter 502 and the receiver 503. For example, in a case that the communication processor 501, the transmitter 502 and the receiver 503 perform wireless communication in compliance with IEEE802.11 standard, the second wireless communication module 506 may perform wireless communication in compliance with another wireless communication standard such as Bluetooth (trademark), LTE, Wireless HD or the like. The communication processor 501, the transmitter 502, the receiver 503 may perform wireless communication at 2.4 GHz/5 GHz and the second wireless communication module 506 may perform wireless communication at 60 GHz.

In the embodiment, one antenna is arranged and shared by the transmitter 502, the receiver 503 and the second wireless communication module 506. A switch controlling for connection destination of the antenna 51A may be arranged and thereby the antenna may be shared. A plurality of antennas may be arranged and may be employed by the transmitter 502, the receiver 503, and the second wireless communication module 506, respectively.

As one example, the communication processor 501 corresponds to an integrated circuit, and the transmitter 502 and the receiver 503 corresponds to an RF integrated circuit which transmits and receives frames. A set of the communication processor 501 and the application processor 504 is configured by one integrated circuit (1 chip). A part of the second wireless communication module 506 and the application processor 504 may be configured by one integrated circuit (1 chip).

The application processor performs control of wireless communication through the communication processor 501 and wireless communication through the second wireless communication module 506.

### Eighth Embodiment

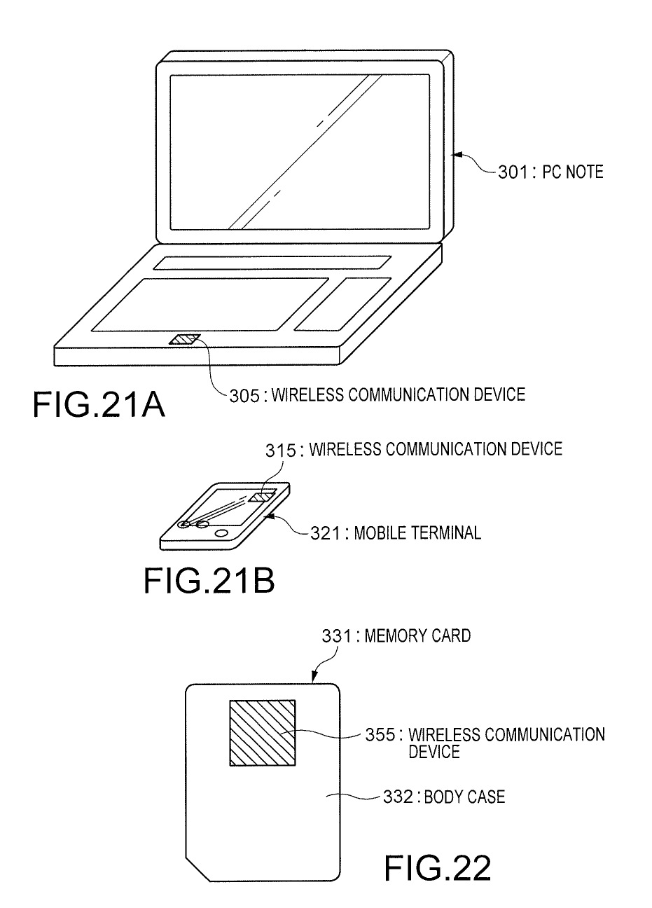

FIG. 21A and FIG. 21B are perspective views of wireless terminal according to the fourth embodiment. The wireless terminal in FIG. 21A is a notebook PC 301 and the wireless communication device (or a wireless device) in FIG. 21B is a mobile terminal 321. Each of them corresponds to one form of a terminal (which may indicate a base station). The notebook PC 301 and the mobile terminal 321 are equipped with wireless communication devices 305 and 315, respectively. The wireless communication device provided in a terminal (which may indicate a base station) which has been described above can be used as the wireless communication devices 305 and 315. A wireless terminal carrying a wireless communication device is not limited to notebook PCs and mobile terminals. For example, it can be installed in a TV, a digital camera, a wearable device, a tablet, a smart phone, a gaming device, a network storage device, a monitor, a digital audio player, a web camera, a video camera, a projector, a navigation system, an external adapter, an internal adapter, a set top box, a gateway, a printer server, a mobile access point, a router, an enterprise/service provider access point, a portable device, a handheld device, vehicle and so on.

Moreover, a wireless communication device installed in a terminal (which may indicate a base station) can also be provided in a memory card. FIG. 22 illustrates an example of a wireless communication device mounted on a memory card. A memory card 331 contains a wireless communication device 355 and a body case 332. The memory card 331 uses the wireless communication device 355 for wireless communication with external devices (the terminal, the access point or both of them etc.). Here, in FIG. 22, the description of other installed elements (for example, a memory, and so on) in the memory card 331 is omitted.

### Ninth Embodiment

In the fifth embodiment, a bus, a processor unit and an external interface unit are provided in addition to the configuration of the wireless communication device (which may indicate the wireless communication device mounted in the terminal, the wireless communication device mounted in the access point or both of them) according to any of the embodiments. The processor unit and the external interface unit are connected with an external memory (a buffer) through the bus. A firmware operates the processor unit. Thus, by adopting a configuration in which the firmware is included in the wireless communication device, the functions of the wireless communication device can be easily changed by rewriting the firmware. The processing unit in which the firmware operates may be a processor that performs the process of the communication controlling device or the control unit according to the present embodiment, or may be another processor that performs a process relating to extending or altering the functions of the process of the communication controlling device or the control unit. The processing unit in which the firmware operates may be included in the base station or the wireless terminal according to the present embodiment. Alternatively, the processing unit may be included in the integrated circuit of the wireless communication device installed in the base station, or in the integrated circuit of the wireless communication device installed in the wireless terminal.

### Tenth Embodiment

In the present embodiment, a clock generating unit is provided in addition to the configuration of the wireless communication device (which may indicate the wireless communication device mounted in the terminal, the wireless communication device mounted in the access point or both of them) according to any of the embodiments. The clock generating unit generates a clock and outputs the clock from an output terminal to the exterior of the wireless communication device. Thus, by outputting to the exterior the clock generated inside the wireless communication device and operating the host by the clock output to the exterior, it is possible to operate the host and the wireless communication device in a synchronized manner.

### Eleventh Embodiment

In the present embodiment, a power source unit, a power source controlling unit and a wireless power feeding unit are included in addition to the configuration of the wireless communication device (which may indicate the wireless communication device mounted in the terminal, the wireless communication device mounted in the access point or both of them) according to any of embodiments. The power supply controlling unit is connected to the power source unit and to the wireless power feeding unit, and performs control to select a power source to be supplied to the wireless communication device. Thus, by adopting a configuration in which the power source is included in the wireless communication device, power consumption reduction operations that control the power source are possible.

### Twelfth Embodiment

In the present embodiment, a SIM card is added to the configuration of the wireless communication device according to any of the embodiments. For example, the SIM card is connected with the transmitter, the receiver, the controller or a plurality of them in the wireless communication device. Thus, by adopting a configuration in which the SIM card is included in the wireless communication device, authentication processing can be easily performed.

### Thirteenth Embodiment

In the present embodiment, a video image compressing/decompressing unit is added to the configuration of the wireless communication device according to the sixteenth embodiment. The video image compressing/decompressing unit is connected to the bus. Thus, by adopting a configuration in which the video image compressing/decompressing unit is included in the wireless communication device, transmitting a compressed video image and decompressing a received compressed video image can be easily done.

### Fourteenth Embodiment

In the present embodiment, an LED unit is added to the configuration of the wireless communication device (which may indicate the wireless communication device mounted in the terminal, the wireless communication device mounted in the access point or both of them) according to any of the embodiments. For example, the LED unit is connected to the transmitter, the receiver, the controller or a plurality of them in the wireless communication device. Thus, by adopting a configuration in which the LED unit is included in the wireless communication device, notifying the operation state of the wireless communication device to the user can be easily done.

### Fifteenth Embodiment

In the present embodiment, a vibrator unit is included in addition to the configuration of the wireless communication device (which may indicate the wireless communication device mounted in the terminal, the wireless communication device mounted in the access point or both of them) according to any of the embodiments. For example, the vibrator unit is connected to the transmitter, the receiver, the controller or a plurality of them in the wireless communication device. Thus, by adopting a configuration in which the vibrator unit is included in the wireless communication device, notifying the operation state of the wireless communication device to the user can be easily done.

### Sixteenth Embodiment

In the present embodiment, the configuration of the wireless communication device includes a display in addition to the configuration of the wireless communication device (which may indicate the wireless communication device mounted in the terminal, the wireless communication device mounted in the access point or both of them) according to any one of the above embodiments. The display may be connected to the controller. As seen from the above, the configuration including the display to display the operation state of the wireless communication device on the display allows the operation status of the wireless communication device to be easily notified to a user.

### Seventeenth Embodiment

In the present embodiment, [1] the frame type in the wireless communication system, [2] a technique of disconnection between wireless communication devices, [3] an access scheme of a wireless LAN system and [4] a frame interval of a wireless LAN are described.

### [1] Frame Type in Communication System

Generally, as mentioned above, frames treated on a wireless access protocol in a wireless communication system are roughly divided into three types of the data frame, the management frame and the control frame. These types are normally shown in a header part which is commonly provided to frames. As a display method of the frame type, three types may be distinguished in one field or may be distinguished by a combination of two fields. In IEEE 802.11 standard, identification of a frame type is made based on two fields of Type and Subtype in the Frame Control field in the header part of the MAC frame. The Type field is one for generally classifying frames into a data frame, a management frame, or a control frame and the Subtype field is one for identifying more detailed type in each of the classified frame types such as a beacon frame belonging to the management frame.

The management frame is a frame used to manage a physical communication link with a different wireless communication device. For example, there are a frame used to perform communication setting with the different wireless communication device or a frame to release communication link (that is, to disconnect the connection), and a frame related to the power save operation in the wireless communication device.

The data frame is a frame to transmit data generated in the wireless communication device to the different wireless communication device after a physical communication link with the different wireless communication device is established. The data is generated in a higher layer of the present embodiment and generated by, for example, a user's operation.

The control frame is a frame used to perform control at the time of transmission and reception (exchange) of the data frame with the different wireless communication device. A response frame transmitted for the acknowledgment in a case where the wireless communication device receives the data frame or the management frame, belongs to the control frame. The response frame is, for example, an ACK frame or a BlockACK frame. The RTS frame and the CTS frame are also the control frame.

These three types of frames are subjected to processing based on the necessity in the physical layer and then transmitted as physical packets via an antenna. In IEEE 802.11 standard (including the extended standard such as IEEE Std 802.11ac-2013), an association process is defined as one procedure for connection establishment. The association request frame and the association response frame which are used in the procedure are a management frame. Since the association request frame and the association response frame is the management frame transmitted in a unicast scheme, the frames causes the wireless communication terminal in the receiving side to transmit an ACK frame being a response frame. The ACK frame is a control frame as described in the above.

### [2] Technique of Disconnection Between Wireless Communication Devices

For disconnection of the connection (release), there are an explicit technique and an implicit technique. As the explicit technique, a frame to disconnect any one of the connected wireless communication devices is transmitted. This frame corresponds to Deauthentication frame defined in IEEE 802.11 standard and is classified into the management frame. Normally, it is determined that the connection is disconnected at the timing of transmitting the frame to disconnect the connection in a wireless communication device on the side to transmit the frame and at the timing of receiving the frame to disconnect the connection in a wireless communication device on the side to receive the frame. Afterward, it returns to the initial state in a communication phase, for example, a state to search for a wireless communication device of the communicating partner. In a case that the wireless communication base station disconnects with a wireless communication terminal, for example, the base station deletes information on the wireless communication device from a connection management table if the base station holds the connection management table for managing wireless communication terminals which entries into the BSS of the base station-self. For example, in a case that the base station assigns an AID to each wireless communication terminal which entries into the BSS at the time when the base station permitted each wireless communication terminal to connect to the base station-self in the association process, the base station deletes the held information related to the AID of the wireless communication terminal disconnected with the base station and may release the AID to assign it to another wireless communication device which newly entries into the BSS.

On the other hand, as the implicit technique, it is determined that the connection state is disconnected in a case where frame transmission (transmission of a data frame and management frame or transmission of a response frame with respect to a frame transmitted by the subject device) is not detected from a wireless communication device of the connection partner which has established the connection for a certain period. Such a technique is provided because, in a state where it is determined that the connection is disconnected as mentioned above, a state is considered where the physical wireless link cannot be secured, for example, the communication distance to the wireless communication device of the connection destination is separated and the radio signals cannot be received or decoded. That is, it is because the reception of the frame to disconnect the connection cannot be expected.

As a specific example to determine the disconnection of connection in an implicit method, a timer is used. For example, at the time of transmitting a data frame that requests an acknowledgment response frame, a first timer (for example, a retransmission timer for a data frame) that limits the retransmission period of the frame is activated, and, if the acknowledgement response frame to the frame is not received until the expiration of the first timer (that is, until a desired retransmission period passes), retransmission is performed. When the acknowledgment response frame to the frame is received, the first timer is stopped.

On the other hand, when the acknowledgment response frame is not received and the first timer expires, for example, a management frame to confirm whether a wireless communication device of a connection partner is still present (in a communication range) (in other words, whether a wireless link is secured) is transmitted, and, at the same time, a second timer (for example, a retransmission timer for the management frame) to limit the retransmission period of the frame is activated. Similarly to the first timer, even in the second timer, retransmission is performed if an acknowledgment response frame to the frame is not received until the second timer expires, and it is determined that the connection is disconnected when the second timer expires.

Alternatively, a third timer is activated when a frame is received from a wireless communication device of the connection partner, the third timer is stopped every time the frame is newly received from the wireless communication device of the connection partner, and it is activated from the initial value again. When the third timer expires, similarly to the above, a management frame to confirm whether the wireless communication device of the connection party is still present (in a communication range) (in other words, whether a wireless link is secured) is transmitted, and, at the same time, a second timer (for example, a retransmission timer for the management frame) to limit the retransmission period of the frame is activated. Even in this case, retransmission is performed if an acknowledgment response frame to the frame is not received until the second timer expires, and it is determined that the connection is disconnected when the second timer expires. The latter management frame to confirm whether the wireless communication device of the connection partner is still present may differ from the management frame in the former case. Moreover, regarding the timer to limit the retransmission of the management frame in the latter case, although the same one as that in the former case is used as the second timer, a different timer may be used.

### [3] Access Scheme of Wireless LAN System

For example, there is a wireless LAN system with an assumption of communication or competition with a plurality of wireless communication devices. CSMA/CA is set as the basis of an access scheme in IEEE802.11 (including an extension standard or the like) wireless LAN. In a scheme in which transmission by a certain wireless communication device is grasped and transmission is performed after a fixed time from the transmission end, simultaneous transmission is performed in the plurality of wireless communication devices that grasp the transmission by the wireless communication device, and, as a result, radio signals collide and frame transmission fails. By grasping the transmission by the certain wireless communication device and waiting for a random time from the transmission end, transmission by the plurality of wireless communication devices that grasp the transmission by the wireless communication device stochastically disperses. Therefore, if the number of wireless communication devices in which the earliest time in a random time is subtracted is one, frame transmission by the wireless communication device succeeds and it is possible to prevent frame collision. Since the acquisition of the transmission right based on the random value becomes impartial between the plurality of wireless communication devices, it can say that a scheme adopting Collision Avoidance is a suitable scheme to share a radio medium between the plurality of wireless communication devices.

### [4] Frame Interval of Wireless LAN

The frame interval of IEEE802.11 wireless LAN is described. There are six types of frame intervals used in IEEE802.11 wireless LAN, such as distributed coordination function interframe space (DIFS), arbitration interframe space (AIFS), point coordination function interframe space (PIFS), short interframe space (SIFS), extended interframe space (EIFS) and reduced interframe space (RIFS).

The definition of the frame interval is defined as a continuous period that should confirm and open the carrier sensing idle before transmission in IEEE802.11 wireless LAN, and a strict period from a previous frame is not discussed. Therefore, the definition is followed in the explanation of IEEE802.11 wireless LAN system. In IEEE802.11 wireless LAN, a waiting time at the time of random access based on CSMA/CA is assumed to be the sum of a fixed time and a random time, and it can say that such a definition is made to clarify the fixed time.

DIFS and AIFS are frame intervals used when trying the frame exchange start in a contention period that competes with other wireless communication devices on the basis of CSMA/CA. DIFS is used in a case where priority according to the traffic type is not distinguished, AIFS is used in a case where priority by traffic identifier (TID) is provided.

Since operation is similar between DIFS and AIFS, an explanation below will mainly use AIFS. In IEEE802.11 wireless LAN, access control including the start of frame exchange in the MAC layer is performed. In addition, in a case where QoS (Quality of Service) is supported when data is transferred from a higher layer, the traffic type is notified together with the data, and the data is classified for the priority at the time of access on the basis of the traffic type. The class at the time of this access is referred to as “access category (AC)”. Therefore, the value of AIFS is provided every access category.

PIFS denotes a frame interval to enable access which is more preferential than other competing wireless communication devices, and the period is shorter than the values of DIFS and AIFS. SIFS denotes a frame interval which can be used in a case where frame exchange continues in a burst manner at the time of transmission of a control frame of a response system or after the access right is acquired once. EIFS denotes a frame interval caused when frame reception fails (when the received frame is determined to be error).

RIFS denotes a frame interval which can be used in a case where a plurality of frames are consecutively transmitted to the same wireless communication device in a burst manner after the access right is acquired once, and a response frame from a wireless communication device of the transmission partner is not requested while RIFS is used.

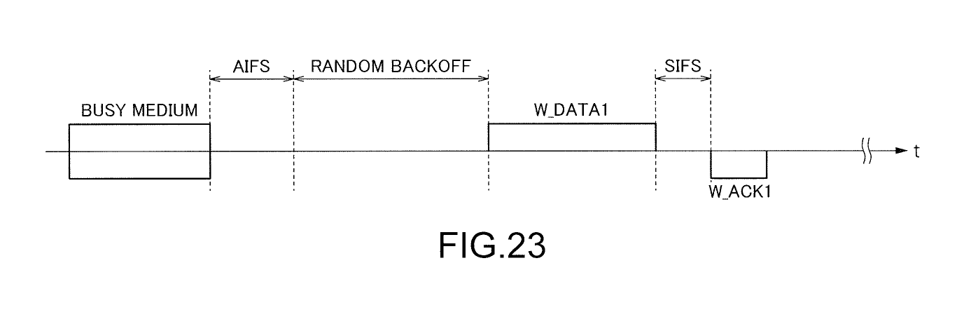

Here, FIG. 23 illustrates one example of frame exchange in a competitive period based on the random access in IEEE802.11 wireless LAN.

When a transmission request of a data frame (W_DATA1) is generated in a certain wireless communication device, a case is assumed where it is recognized that a medium is busy (busy medium) as a result of carrier sensing. In this case, AIFS of a fixed time is set from the time point at which the carrier sensing becomes idle, and, when a random time (random backoff) is set afterward, data frame W_DATA1 is transmitted to the communicating partner.

The random time is acquired by multiplying a slot time by a pseudorandom integer led from uniform distribution between contention windows (CW) given by integers from 0. Here, what multiplies CW by the slot time is referred to as “CW time width”. The initial value of CW is given by CWmin, and the value of CW is increased up to CWmax every retransmission. Similarly to AIFS, both CWmin and CWmax have values every access category. In a wireless communication device of transmission destination of W_DATA1, when reception of the data frame succeeds, a response frame (W_ACK1) is transmitted after SIFS from the reception end time point. If it is within a transmission burst time limit when W_ACK1 is received, the wireless communication device that transmits W_DATA1 can transmit the next frame (for example, W_DATA2) after SIFS.

Although AIFS, DIFS, PIFS and EIFS are functions between SIFS and the slot-time, SIFS and the slot time are defined every physical layer. Moreover, although parameters whose values being set according to each access category, such as AIFS, CWmin and CWmax, can be set independently by a communication group (which is a basic service set (BSS) in IEEE802.11 wireless LAN), the default values are defined.

For example, in the definition of 802.11ac, with an assumption that SIFS is 16 μs and the slot time is 9 μs, and thereby PIFS is 25 μs, DIFS is 34 μs, the default value of the frame interval of an access category of BACKGROUND (AC_BK) in AIFS is 79 μs, the default value of the frame interval of BEST EFFORT (AC_BE) is 43 μs, the default value of the frame interval between VIDEO(AC_VI) and VOICE(AC_VO) is 34 μs, and the default values of CWmin and CWmax are 31 and 1023 in AC_BK and AC_BE, 15 and 31 in AC_VI and 7 and 15 in AC_VO. Here, EIFS denotes the sum of SIFS, DIFS, and the time length of a response frame transmitted at the lowest mandatory physical rate. In the wireless communication device which can effectively takes EIFS, it may estimate an occupation time length of a PHY packet conveying a response frame directed to a PHY packet due to which the EIFS is caused and calculates a sum of SIFS, DIFS and the estimated time to take the EIFS.

Note that the frames described in the embodiments may indicate not only things called frames in, for example, IEEE 802.11 standard, but also things called packets, such as Null Data Packets.

The terms used in each embodiment should be interpreted broadly. For example, the term “processor” may encompass a general purpose processor, a central processing unit (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, or one or more microprocessors in conjunction with a DSP core.

As another example, the term “memory” may encompass any electronic component which can store electronic information. The “memory” may refer to various types of media such as a random access memory (RAM), a read-only memory (ROM), a programmable read-only memory (PROM), an erasable programmable read only memory (EPROM), an electrically erasable PROM (EEPROM), a non-volatile random access memory (NVRAM), a flash memory, and a magnetic or optical data storage, which are readable by a processor. It can be said that the memory electronically communicates with a processor if the processor read and/or write information for the memory. The memory may be arranged within a processor and also in this case, it can be said that the memory electronically communication with the processor.

In the specification, the expression “at least one of a, b or c” is an expression to encompass not only “a”, “b”, “c”, “a and b”, “a and c”, “b and c”, “a, b and c” or any combination thereof but also a combination of at least a plurality of same elements such as “a and a”, “a, b and b” or “a, a, b, b, c and c”. Also, the expression is an expression to allow a set including an element other than “a”, “b” and “c” such as “a, b, c, and d”.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

1. An electronic apparatus, comprising:
a receiver configured to receive a first frame in a first frequency band within a first period from a first apparatus; and
a transmitter configured to transmit a second frame in the first frequency band within the first period to a second apparatus,
wherein a transmission power of the second frame depends on both a reception quality required by the second apparatus to receive the second frame and an amount of interference from the first apparatus to the second apparatus.

2. The electronic apparatus according to claim 1, further comprising controlling circuitry configured to determine a transmission power for the second frame, based on a transmission power for the first frame, a first path loss that is a path loss from the first apparatus to the second apparatus, a second path loss that is a path loss from an own device to the second apparatus, and the reception quality,
wherein the transmitter transmits the second frame with the transmission power determined by the controlling circuitry.

3. The electronic apparatus according to claim 1, wherein the controlling circuitry determines the transmission power for the second frame, based on an amount of interference applied by a transmission signal of the second frame to a reception signal of the first frame in an own device, and on a reception quality required to receive the first frame.

4. The electronic apparatus according to claim 2, wherein the controlling circuitry determines the transmission power for the second frame, based on a third path loss that is a path loss from the first apparatus to the own device.

5. The electronic apparatus according to claim 1, further comprising controlling circuitry configured to determine a transmission power for the first frame, based on a first path loss that is a path loss from the first apparatus to the second apparatus, a second path loss that is a path loss from an own device to the second apparatus, the reception quality, and a transmission power for the second frame,
wherein the transmitter transmits information that specifies the transmission power determined by the controlling circuitry, to the first apparatus.

6. The electronic apparatus according to claim 2, wherein the receiver receives information that represents the first path loss, from the second apparatus.

7. The electronic apparatus according to claim 2, wherein the receiver receives information that represents the second path loss, from the second apparatus.

8. The electronic apparatus according to claim 1, wherein the transmitter multiplexes and transmits a plurality of the second frames to a plurality of the transmission destination devices in the predetermined frequency band.

9. The electronic apparatus according to claim 1, wherein the receiver receives a plurality of the first frames multiplexed and transmitted from a plurality of the transmission source devices in the predetermined frequency band.

10. The wireless communication device according to claim 1, further comprising at least one antenna.

11. A wireless communication method, comprising:
receiving a first frame in a first frequency band within a first period from a first apparatus; and
transmitting a second frame in the first frequency band within the first period to a second apparatus,
wherein a transmission power of the second frame depends on both a reception quality required by the second apparatus to receive the second frame and an amount of interference from the first apparatus to the second apparatus.
